(19) United States
(12) Patent Application Publication
(10) Pub. No.: US 2012/0138533 A1
(43) Pub. Date: Jun. 7, 2012

(54) DIALYSIS SYSTEM CONTROL SYSTEM WITH USER INTERFACE

(76) Inventors: James R. Curtis, Portland, OR (US); Michael J. Baker, Gig Harbor, WA (US)

(21) Appl. No.: 13/308,964

(22) Filed: Dec. 1, 2011

Related U.S. Application Data
(60) Provisional application No. 61/418,753, filed on Dec. 1, 2010.

(51) Int. Cl. B01D 61/00; B01D 35/14

(52) U.S. Cl. 210/646; 210/85

(57) ABSTRACT

Disclosed herein are systems and methods of using such systems including a dialysis system, a dialysis system controller operatively coupled to a filtration system, water purification system, dialysate preparation system and dialyzer system of the dialysis system, and a user interface communicatively coupled to the dialysis system controller. The user interface is configured to enable user interaction with the dialysis system and guide a user step-wise through set-up and shut-down of the dialysis system according to a pre-determined protocol. The user interface communicates with the dialysis system controller to activate an alarm condition when a deviation from the pre-determined protocol is sensed.

### REFERENCE TO PRIORITY DOCUMENT

This application is related to and claims the benefit of priority under 35 U.S.C. 119(e) of U.S. Provisional Application Ser. No. 61/418,753, titled, “Dialysis System User Interface,” filed Dec. 1, 2010. Priority of the filing date of Dec. 1, 2010 is hereby claimed, and the disclosure of the provisional patent application is hereby incorporated by reference in its entirety.

### BACKGROUND

There are, at present, hundreds of thousands of patients in the United States with end-stage renal disease. Most of those require dialysis to survive. United States Renal Data System projects the number of patients in the U.S. on dialysis will climb past 600,000 by 2012.

Many patients receive dialysis treatment at a dialysis center, which can place a demanding, restrictive and tiring schedule on a patient. Patients who receive in-center dialysis typically must travel to the center at least three times a week and sit in a chair for 3 to 4 hours each time while toxins and excess fluids are filtered from their blood. After the treatment, the patient must wait for the needle site to stop bleeding and blood pressure to return to normal, which requires even more time taken away from other, more fulfilling activities in their daily lives. Moreover, in-center patients must follow an uncompromising schedule as a typical center treats three to five shifts of patients in the course of a day. As a result, many people who dialyze three times a week complain of feeling exhausted for at least a few hours after a session.

Given the demanding nature of in-center dialysis, many patients have turned to home dialysis as an option. Home dialysis provides the patient with ability to perform dialysis in the comfort of his or her home. Home dialysis also provides the patient with scheduling flexibility as it permits the patient to choose treatment times to fit other activities, such as going to work or caring for a family member. Unfortunately, conventional home dialysis systems can be difficult for a patient to operate due to cumbersome and unwieldy control systems and user interfaces.

A cumbersome and unwieldy user interface for a control system is a particular drawback for a dialysis system that is operated in the patient's home, where the user typically does not have access to the advice of a clinician to answer the patient's questions. This may lead to the patient choosing to forego home dialysis and return to the inconvenience of in-center dialysis. Or, it may lead to the patient operating the home dialysis system in an improper manner due to miscommunication between the user interface and the patient, sometimes with dire consequences.

### SUMMARY

In view of the foregoing, there is a need for an improved user interface and control system for a home dialysis system.

In one aspect, disclosed is a system. The system includes a dialysis system having a filtration system configured to filter a water stream, a water purification system configured to purify the water stream in a non-batch process, a dialysate preparation system configured to produce a stream of dialysate from mixing one or more dialysate components with the water stream in a non-batch process, and a dialyzer system. The dialyzer system includes a dialyzer configured to fluidly couple to the stream of dialysate and a blood stream. The dialyzer has a membrane separating the stream of dialysate from the blood stream, the membrane facilitating dialysis of the blood stream. The dialyzer has a plurality of pumps configured to pump the stream of dialysate across the dialyzer. The system also includes a dialysis system controller operatively coupled to the filtration system, water purification system, dialysate preparation system and dialyzer system. The system also includes a user interface communicatively coupled to the dialysis system controller. The user interface is configured to enable user interaction with the dialysis system and guide a user step-wise through set-up and shut-down of the dialysis system according to a pre-determined protocol. The user interface communicates with the dialysis system controller to activate an alarm condition when a deviation from the pre-determined protocol is sensed.

The dialyzer can be a microfluidic dialyzer, hollow fiber dialyzer or a flow field dialyzer. The dialysis system controller can be configured to control a flow rate of the dialysate stream through one or more of the plurality of pumps so as to perform one or both of the processes of ultrafiltration and hemodiafiltration on the blood stream while the blood stream is undergoing dialysis.

The alarm condition can prevent operation of the dialysis system. The alarm condition can prevent operation of at least one of the filtration system, the water purification system, the dialysate preparation system and the dialyzer system. The alarm condition can alert a medical practitioner via a text message, telephone call, email, or a combination thereof. The user can be a dialysis patient on which the dialysis is performed. The dialysis patient can be a home dialysis patient. The user can be a caregiver to a dialysis patient. The control system can prevent unsafe operation of the dialysis system by the user. Unsafe operation of the dialysis system can include use with the filtration system not filtering the water stream suitably, use with water purification system not purifying the water stream suitably, use with the mixing system not producing dialysate suitably, use with the dialyzer system not flowing the stream of dialysate suitably, use with the dialyzer system not flowing the blood stream suitably, use with the dialyzer system not performing ultrafiltration and/or hemodiafiltration suitably, use with concentrate solution that is not suitable for use with a specific patient that is to be treated, use with concentrate solution that has not been prescribed for a patient by a medical practitioner or any combination thereof.

The system can further include a patient monitoring system having one or more sensors configured to detect information regarding a patient condition. The patient monitoring system can be in communication with the user interface. The patient monitoring system can be configured to record the information regarding a patient condition and relay the information to the user interface. The one or more sensors can include a detachment sensor that detects detachment of an access line from a patient venous needle insertion site to the dialysis system. The patient monitoring system can further include a patient blood pressure monitor. The one or more sensors can include a sensor to detect patient alertness. The user interface or dialysis system controller can prevent use of the dialysis system by the user when the patient monitoring system detects that a patient condition falls outside of a range safe for dialysis to proceed.

The system can further include one or more sensors that detect information regarding a dialysis system condition. The dialysis system condition can include maintenance required by the dialysis system, lack of information from the dialysis system, a change in flow rates within the dialysis system, inability of the dialysis system to achieve desired flow rates or temperatures, and detachment of the dialysis system from the patient. The pre-determined protocol can include: installation of components to the dialysis system, attachment of the patient to the dialysis system, attachment of a detachment sensor to the patient, testing of solutions generated by the dialysis system, confirmation of the treatment parameters, measurement of patient status, opening and closing clamps on fluid flow lines, performing maintenance on the dialysis system, and priming of fluid lines or pumps. The deviation from the pre-determined protocol can include improper installation of one or more components to the dialysis system, improper attachment of the patient to the dialysis system, failure to obtain patient status measurements that indicate it is safe to proceed with dialysis treatment, failure to maintain the dialysis system, and failure to respond to alerts, alarms, or prompts from the user interface. The user interface can be configured to interact with multiple users. The users can include a dialysis patient, a caregiver to a dialysis patient, a medical treatment provider, and a medical service provider.

In a related aspect, disclosed is a method of performing dialysis with a dialysis system. The method includes prompting a user for input using a user interface. The user interface is in communication with a dialysis system and configured to enable user interaction with the dialysis system and guide the user step-wise through set-up and shut-down of the dialysis system according to a pre-determined protocol. The dialysis system includes a filtration system configured to filter a water stream, a water purification system configured to purify the water stream in a non-batch process, a dialysate preparation system configured to produce a stream of dialysate from mixing one or more dialysate components with the water stream in a non-batch process, and a dialyzer system. The dialyzer system includes a dialyzer configured to fluidly couple to the stream of dialysate and a blood stream. The dialyzer includes a membrane separating the stream of dialysate from the blood stream, the membrane facilitating dialysis of the blood stream. The dialyzer system includes a plurality of pumps configured to pump the stream of dialysate across the dialyzer. The system also includes a dialysis system controller operatively coupled to the dialyzer system, the filtration system, the water purification system, the dialysate preparation system, and the user interface. The method also includes communicating the user input to the dialysis system controller, obtaining status information from the dialysis system via one or more system sensors, communicating the dialysis system status information to the dialysis system controller, receiving information of one or more patient conditions of a patient attached to the dialysis system, determining that the one or more patient conditions are suitable for dialysis treatment, determining that the dialysis system status is suitable for dialysis treatment, and using the user interface to operate the dialysis system.

The user input can include direction to begin dialysis treatment start-up, changes to dialysis treatment parameters, confirmation of dialysis treatment parameters, patient status or condition information, confirmation of the performance of tasks during treatment start-up or shut-down, direction to start dialysis treatment, direction to stop dialysis treatment, acknowledgement of an alert or alarm, or any combination thereof. The method can further include alerting or alarming the user when a deviation from the pre-determined protocol is detected. Deviation from the pre-determined protocol can include improper installation of one or more components to the dialysis system, improper attachment of the patient to the dialysis system, failure to obtain patient condition measurements that indicate it is safe to proceed with dialysis treatment, failure to maintain the dialysis system, and failure to respond to alerts, alarms, or prompts from the user interface.

Other features and advantages should be apparent from the following description of various embodiments, which illustrate, by way of example, the principles of the disclosed devices and methods.

### BRIEF DESCRIPTION OF THE DRAWINGS

FIG. 1 shows a high level, schematic view of a dialysis system.

FIG. 2 shows a high level, schematic view of an implementation of a dialysis system that can be controlled using a user interface described herein.

FIG. 3 shows a flow diagram of an interaction between a user and a user interface during system start-up.

FIG. 4 shows a block diagram of an implementation of a user interface.

FIG. 5 shows a variation of a visual presentation of information from the user interface as a welcome page.

FIG. 6 shows a variation of a visual presentation of information from the user interface prompting pre-treatment setup of a dialysis system including how a user may install a blood set.

FIG. 7 shows a variation of a visual presentation of information from the user interface prompting pre-treatment setup of a dialysis system including how a user may attach a saline solution source.

FIG. 8 shows a variation of a visual presentation of information from the user interface prompting pre-treatment setup of a dialysis system including how a user may install a dialyzer unit.

FIG. 9 shows a variation of a visual presentation of information from the user interface prompting pre-treatment setup of a dialysis system including how a user may prepare a heparin dosing device.

FIG. 10 shows a variation of a visual presentation of information from the user interface prompting pre-treatment setup of a dialysis system including how a user may prepare a recirculation connector.

FIG. 11 shows a variation of a visual presentation of information from the user interface prompting pre-treatment setup of a dialysis system including how installation of dialysate concentrate bags may be done.

FIG. 12 shows a variation of a visual presentation of information from the user interface prompting pre-treatment setup of a dialysis system including treatment confirmation.

FIG. 13 shows a variation of a visual presentation of information from the user interface prompting pre-treatment setup of a dialysis system including treatment confirmation.

FIG. 14 shows a variation of a visual presentation of information from the user interface prompting pre-treatment setup of a dialysis system including how a chlorine test of fluid from a dialysis system may be performed.

FIG. 15 shows a variation of a visual presentation of information from the user interface prompting pre-treatment setup of a dialysis system including how a user may be prompted to take a pre-treatment blood pressure reading.

FIG. 16 shows a variation of a visual presentation of information from the user interface prompting pre-treatment setup of a dialysis system including how access to the venous and arterial blood flow of a patient may be achieved.

FIG. 17 shows a variation of a visual presentation of information from the user interface prompting pre-treatment setup of a dialysis system including how an attachment dislodgement sensor may be attached.

FIG. 18 shows a variation of a visual presentation of information from the user interface prompting pre-treatment setup of a dialysis system including tasks that may be involved in blood set installation.

FIG. 19 shows a variation of a visual presentation of information from the user interface prompting pre-treatment setup of a dialysis system including tasks that may be involved in blood set installation.

FIG. 20 shows a variation of a visual presentation of information from the user interface while dialysis treatment is in progress including treatment statistics that may be presented.

FIG. 21 shows a variation of a visual presentation of information from the user interface while dialysis treatment is in progress including settings that may be presented and changed.

FIG. 22 shows a variation of a visual alarm provided by the user interface.

FIG. 23 shows a variation of a visual alarm provided by the user interface.

FIG. 24 shows a variation of a visual alarm provided by the user interface.

FIG. 25 shows a variation of a visual prompt upon completion of dialysis treatment provided by the user interface.

FIG. 26 shows a variation of a visual prompt provided by the user interface prompting a user to perform tasks that may be associated with the rinse back step of the post-treatment process.

FIG. 27 shows a variation of a visual prompt provided by the user interface prompting a user to perform the first task that may be associated with the patient disconnect step of the post-treatment process.

FIG. 28 shows a variation of a visual prompt provided by the user interface prompting a user to perform tasks that may be associated with the patient disconnect step of the post-treatment process.

FIG. 29 shows a variation of a visual prompt provided by the user interface prompting a user to perform tasks that may be associated with the post-treatment blood pressure step of the post-treatment process.

FIG. 29 shows a variation of a visual prompt provided by the user interface prompting a user to confirm information that may be associated with the post-treatment information step of the post-treatment process.

FIG. 30 shows a variation of a visual prompt provided by the user interface prompting a user to confirm information that may be associated with the post-treatment information step of the post-treatment process.

FIG. 31 shows a variation of a visual prompt provided by the user interface prompting a user to perform tasks that may be associated with the draining dialysate step of the post-treatment process.

FIG. 32 shows a variation of a visual prompt provided by the user interface prompting a user to perform tasks that may be associated with the drain and rinse concentrates step of the post-treatment process.

### DETAILED DESCRIPTION

In order to promote an understanding of the principals of the disclosure, reference is made to the drawings and the embodiments illustrated therein. Nevertheless, it will be understood that the drawings are illustrative and no limitation of the scope of the disclosure is thereby intended. Any such alterations and further modifications in the illustrated embodiments, and any such further applications of the principles of the disclosure as illustrated herein are contemplated as would normally occur to one of ordinary skill in the art.

During performance of dialysis outside of a clinic and without the presence of a trained medical practitioner, it is desirable to have a system that reassures the recipient of dialysis that the prescribed treatment will be done correctly. A system is provided which may accept the parameters of a prescribed hemodialysis treatment from a medical practitioner along with patient status information through a user interface to control the actions of a dialysis system while conveying status information through the user interface. In some embodiments, a dialysis system that includes a water filtration system, water purification system, and dialyzer, is used with a patient monitoring system to provide information to a user interface which in turn may control performance of the dialysis system, send signals to prevent use of the dialysis system when component systems are not in working order, or safely end treatment when patient status or patient condition information requires it. It should be appreciated that although the user interface is described herein as being incorporated in a home dialysis system operated primarily by a patient or home health care worker, that the user interface can also be advantageous for use with a system located and used in a clinic or medical setting and operated by a medical technician or provider.

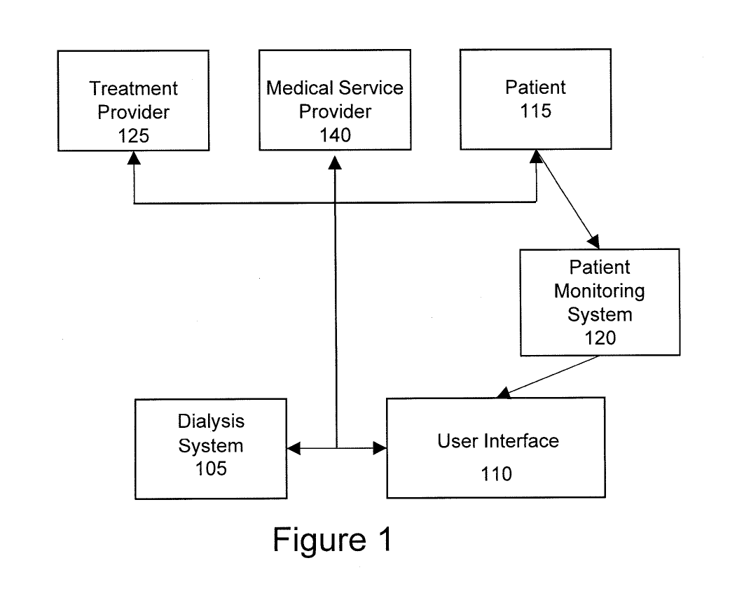

FIG. 1 shows a high level, schematic view of a dialysis system 105 that includes and/or interfaces with a user interface 110. The user interface 110 can be configured to enable one or more users to interact with the dialysis system 105, as described in detail below. In some implementations, the one or more users can include a treatment provider 125, a medical service provider 140, and/or a patient 115. The dialysis system 105 can include a controller that is in functional communication with the user interface 110.

The user interface 110 can include software and/or hardware components that enable interaction between the user and the controller of the dialysis system 105. In this regard, the user interface 110 includes and/or interfaces with components such as, for example, one or more sensors, alarms, input means, etc. that enable the user to provide instructions to the controller of the dialysis system 105 (or otherwise manipulate the system) and also permit the dialysis system 105 to output one or more indications to the user. The user interface 110 may include a secondary controller that coordinates communication between the user interface 110 and the components that enable the user to provide instructions to the dialysis system controller. The system may also include a third controller that coordinates remote communication with the treatment provider 125, a medical service provider 140 or other appropriate entity. The user interface 110 may be part of the dialysis system 105, such as contained within a housing of the dialysis system 105. Alternatively, the user interface 110 may be a separate component that couples to the dialysis system 105 either through a hardwired connection or through a wireless connection.

The patient 115 may be connected to a patient monitoring system 120 that is in communication with one or more sensors coupled to the patient 115. The user interface 110 may communicate with the patient monitoring system 120. The patient monitoring system 120 can receive information regarding the patient's status or condition before, during and/or after dialysis treatment and may transmit the data to the user interface 110. The user interface 110 may communicate with the patient monitoring system 120 either through a hardwired connection or through a wireless connection. The user interface 110 may use the information received from the patient monitoring system 120 to provide instructions to the controller of the dialysis system 105 or to indicate to the patient 115, or other user, the status of the patient through the user interface 110.

Still with respect to FIG. 1, the one or more users that interact with the dialysis system 105 via the user interface 110 can include, for example, a patient 115, a treatment provider entity 125, and/or a medical service provider entity 140 or another appropriate entity. The patient 115 is an individual on which dialysis is performed by the dialysis system 105. The user interface for the patient is configured to focus on the patient's interaction with the dialysis system and its treatment parameters. In this regard, the user interface is configured to provide information that is specific to that patient's treatment cycle and outcomes, such as safety features, alarms, and notifications, as described in more detail below. The user interface for the patient may be used by the patient himself or herself, or by a care-giver assisting the patient. The user interface for the provider entity 125 is configured is to provide information to a related to the patient's biomedical, biometric and treatment outcomes at a level that will be meaningful for a medical provider such as a dialysis nurse, physician, nephrologist or other para-medical professionals. Additional features for such a user interface may include monitoring and information related to billing, medication plans, ordering of supplies, scheduling doctor appointments, and other patient care interactions. The user interface for the medical service provider 140 is configured to enable interaction related to the dialysis system input/output, monitoring of preventative maintenance schedules, software updates, etc. The user interface is configured to be remotely accessed such as via a telecommunications network or to be accessed solely at a specific location. This remote access may be accomplished using a separate user communication system controller that not only allows for remote changing of parameters, but for automated sending of information.

Some embodiments of a dialysis system are described herein for purposes of example although it should be appreciated that the configuration of the dialysis system 105 can vary. In an embodiment, the dialysis system 105 can include a plurality of subsystems that collectively operate to (1) receive and purify water; (2) use the water to prepare dialysate; and (3) supply the dialysate to a dialyzer that may perform various types of dialysis on the blood of a patient such as hemodialysis, ultrafiltration and hemodiafiltration. The dialysis system includes plumbing that provides fluid pathways for water, dialysate, and blood to flow through the dialysis system, as well as one or more pumps that interface with the plumbing for driving fluid flow through the system. The dialysis system can also include one or more sensors, such as fluid flow sensors, pressure sensors, conductivity sensors, etc. for sensing and reporting one or more characteristics of fluid flowing through the system. In an embodiment, the subsystems of the dialysis system are controlled by a dialysis system controller that may operate the pumps and/or valves.

In an embodiment, the entire dialysis system (including the water preparation and purification system, dialysate preparation system, flow balancer system, dialyzer, and hardware, such as plumbing and sensors) is contained within a single housing that is compact and portable. In addition, the dialysis system can prepare dialysate using tap water, such as tap water from a home or hotel room. In an embodiment, the entire dialysis system consumes less than about 22″ by 14″ by 9″ of space when dry, which generally corresponds to the size limit for carry-on baggage of an airline. In an embodiment, the dialysis system is about 24×19.5×12″ in size. In an embodiment, the entire dialysis system weighs less than about fifty pounds when dry. In an embodiment, the entire dialysis system weighs about 46.5 pounds when dry.

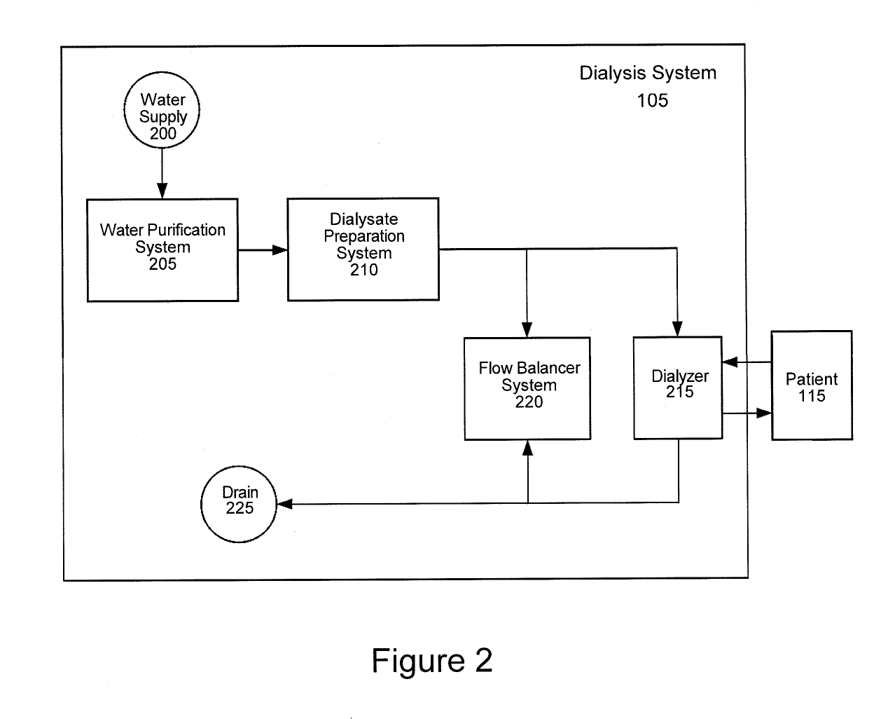

FIG. 2 shows a high level, schematic view of a variation of a dialysis system that can be controlled using the user interface. The dialysis system 105 includes a water preparation and purification system 205 that purifies water from a water supply 200. The water purification system 205 supplies the purified water to a dialysate preparation system 210 that uses the purified water and concentrates to prepare dialysate. The dialysis system further includes a dialyzer 215 that receives the dialysate from the dialysate preparation system 210 and performs dialysis on a patient's blood. In an embodiment, the dialyzer 215 and the dialysate preparation system 210 both interface with a flow balancer system 220 that regulates the flow of dialysate to the dialyzer to control the fluid level in the patient and achieve different types of dialysis, including hemodialysis, ultrafiltration, hemofiltration and hemodiafiltration. The dialyzer can include a microfluidic dialyzer, hollow fiber or a flow field dialyzer.

Diffusion is the principal mechanism in which hemodialysis removes waste products such as urea, creatinine, phosphate and uric acid, among others, from the blood. A differential between the chemical composition of the dialysate and the chemical composition of the blood within the dialyzer causes the waste products to diffuse through a membrane from the blood into the dialysate. Ultrafiltration is a process in dialysis where fluid is caused to move across the membrane from the blood into the dialysate, typically for the purpose of removing excess fluid from the patient's blood stream. Along with water, some solutes are also drawn across the membrane via convection rather than diffusion. Ultrafiltration is a result of a pressure differential between a blood compartment and a dialysate compartment in the dialyzer where fluid moves from a higher pressure to a lower pressure. In some circumstances, by design or unintentional consequence, fluid in the dialysate compartment is higher than the blood compartment causing fluid to move from the dialysate compartment into the blood compartment. This is commonly referred to as reverse ultrafiltration.

In hemodiafiltration, a high level of ultrafiltration is created, greater than the amount required to remove fluid from the patient's blood, for the purpose of increasing convective solute transport across the membrane. The amount of fluid in excess of what is required to be removed from the patient's blood must therefore be returned to the blood stream in order to avoid an adverse hemodynamic reaction. This is accomplished by intentionally increasing the pressure in the dialysate compartment of the dialyzer to cause the appropriate amount of reverse ultrafiltration. This process of ultrafiltration alternating with reverse ultrafiltration is often referred to as “push-pull hemodiafiltration.” This is a significant improvement over more common methods of hemodiafiltration where sterile fluid is administered to the patient in a location outside of the dialyzer.

In use, the patient 115 is coupled to the dialysis system 105 such that the patient's blood flows into and out of the dialyzer 215 using devices and techniques known to those skilled in the art, as shown in FIG. 2. The patient 115 or other user (e.g. clinician, caregiver, treatment provider) can interact with the user interface 110 to control one or more aspects of the dialysis system 105 and to also receive feedback from the dialysis system 105 during use. The dialysate preparation system 210 prepares dialysate using water from a household water source, such as a tap, that is prepared through filtration and purification before being mixed with various dialysate concentrates to make the dialysate. The dialysate then flows through the dialyzer 215 in communication with the blood such that one or more of the dialysis processes on the blood is performed. The water purification system 205 includes a plurality of subsystems that collectively operate to purify the water including pasteurization of the water. The purified water is then mixed with dialysate concentrates to form dialysate, which is supplied to the dialyzer 215 and to the flow balancer system 220, which regulates the flow of dialysate to the dialyzer 215 to selectively achieve different types of dialysis, including hemodialysis, ultrafiltration, and hemodiafiltration, as described more fully above. The dialysis system 105 supplies the used dialysate to a drain 225. In an embodiment, the dialysis system 105 recaptures heat from the used dialysate before the used dialysate is sent to the drain 225.

The following pending U.S. patent applications (which are incorporated herein by reference in their entirety) describe various embodiments of dialysis systems and subsystems: (1) U.S. Patent Application Publication No. US 2010-0326916 entitled “Dialysis System;” (2) U.S. Patent Application Publication No. US 2011-0132838 entitled “Dialysis System with Ultrafiltration Control;” (3) U.S. Patent Application Publication No. US 2010-0326914 entitled “Microfluidic Devices;” and (4) U.S. patent application Ser. No. 12/795,382 entitled “Fluid Purification System.”

As described above, the user interface is helpful in ensuring the safe use of a hemodialysis system by a patient or caregiver in the absence of a trained medical practitioner. The user interface is configured to enable user interaction with the dialysis system and guide a user step-wise through set-up and shut-down of the dialysis system according to a pre-determined protocol. As will be described in more detail below, the user interface can communicate with the dialysis system controller to activate an alarm condition when a deviation from the pre-determined protocol is sensed. The pre-determined protocol can include installation of components to the dialysis system, attachment of the patient to the dialysis system, attachment of a detachment sensor to the patient, testing of solutions generated by the dialysis system, confirmation of the treatment parameters, measurement of patient status, opening and closing clamps on fluid flow lines, performing maintenance on the dialysis system, and priming of fluid lines or pumps. Deviation from the pre-determined protocol can include improper installation of one or more components to the dialysis system, improper attachment of the patient to the dialysis system, failure to obtain patient status measurements that indicate it is safe to proceed with dialysis treatment, failure to maintain the dialysis system, and failure to respond to alerts, alarms, or prompts from the user interface.

The user interface described herein may serve to do one or more of the following: monitor the status of maintenance needs of a dialysis system, facilitate the safe start-up and preparation for dialysis treatment, receive information regarding a patient's status and alter dialysis treatment accordingly, and report the treatments to a trained medical practitioner (i.e. treatment provider) who can in turn alter the dialysis treatment after examining the patient. The user interface may be in communication with one or more control systems. The user interface may be in communication with a control system that controls the operation of the dialysis system including the pumps and/or valves of the dialysis system. This dialysis system controller may stop the action of pumps and/or open valves to drain the system in the event of an alarm situation. The user interface may incorporate a secondary controller to communicate with the dialysis system controller. The secondary controller may send information to and receive information from the dialysis system controller during start-up, dialysis treatment, and shut-down and use this information to determine what guidance or prompting to give a user through the user interface. The information sent from the secondary controller to the dialysis system controller may prevent a user from operating the dialysis system in an unsafe manner. Unsafe operation of the dialysis system can vary, including but not limited to use with the filtration system not filtering the water stream suitably; use with the water purification system not purifying the water stream suitably; use with the mixing system not producing dialysate suitably; use with the dialyzer system not flowing the stream of dialysate suitably; use with the dialyzer system not flowing the blood stream suitably; use with the dialyzer system not performing ultrafiltration and/or hemodiafiltration suitably; use with concentrate solution that is not suitable for use with a specific patient that is to be treated; use with concentrate solution that has not been prescribed for a patient by a medical practitioner; and any combination thereof.

During start-up and preparation for dialysis, the dialysis system controller or the secondary controller may arrest or stop progress of a user through the start-up procedure displayed on the user interface if it is detected that any of the steps of the start-up procedure was not completed correctly. During dialysis treatment, the user interface may warn the user of unsafe conditions or discontinue treatment if needed. The user interface through the secondary controller and/or the dialysis system controller communicates with the dialysis system, including the sub-systems of the dialysis system, in such a way that the dialysis system controller or the secondary controller may ascertain the status of the dialysis system and either the dialysis system controller or the secondary controller may direct the operation of the dialysis system before and during a dialysis treatment.

The user interface may also communicate with a patient monitoring system. The patient monitoring system may detect the status of one or more patient conditions, including, but not limited to, the patient's blood pressure, heart rate, alertness, temperature, the connection of the dialysis system to the patient, or any combination thereof. The patient monitoring system may include a blood pressure monitor, a pulse rate monitor, a dislodgement sensor, or any combination thereof. The communication between the patient monitoring system and the user interface may allow the user interface to initiate an alarm when the patient is reacting adversely to the dialysis treatment or has become disconnected from the system. The user interface may also use information communicated to it from the patient monitoring system to prompt the user to action, including reattaching the patient to the system, administering a saline solution bolus, or altering the flow rates of either the dialysate or blood. The user interface may use information communicated to it from the patient monitoring system to direct the dialysis system without input from the user. The communication between the patient monitoring system and the user interface may allow the secondary controller to communicate to the dialysis system controller and prevent further dialysis treatment if a patient condition falls outside of a range safe for dialysis to proceed.

The user interface may request input from a user, prompt the user with instructions for set-up and use, display status information regarding the dialysis system, or any combination thereof. Input that the user interface may request from a user includes: patient mass (i.e. weight), patient food/drink intake, desired treatment time, desired dialysate flow rate, desired dialysate temperature, desired blood flow rate, desired heparin flow rate, initial blood pressure reading type, desired blood pressure measurement intervals, heparin bolus administration, saline solution bolus administration, desired change in blood fluid volume, and results of chemical tests of fluids produced by the dialysis system.

During set-up or preparation for dialysis, the user interface may prompt the user to action including, but not limited to: installation of components to the dialysis system, attachment of the patient to the dialysis system, attachment of the detachment sensor to the patient, testing of solutions generated by the dialysis system, alteration and/or confirmation of the treatment parameters, measurement of patient status, opening and closing clamps on fluid flow lines, performing maintenance on the dialysis system, and priming of fluid lines or pumps. Components of the dialysis system that the user interface may request that the user install include, but are not limited to: a blood set, a saline solution bag from which a saline bolus may be administered, a heparin source from which a heparin bolus may be administered, a dialyzer, a recirculation sensor, and one or more concentrate containers which contribute to the production of dialysate. Tests that the user interface may prompt the user to do on solutions generated by the dialysis system including, but not limited to: chlorine content tests, pH tests, conductivity measurements, and other tests that would indicate the suitability of water or dialysate for use or indicate the efficacy of a treatment. Measurement of patient status prior to dialysis treatment may include, but are not limited to, measuring the following: pulse rate, blood pressure, temperature, weight, any other parameter that may impact the treatment parameters, or any combination thereof.

Status information regarding the dialysis system that the user interface may present includes, but is not limited to, sterilization due date, water filtration system component lifetime, water purification system component lifetime, pump maintenance requirements, or other information that could potentially impact the performance of the system. Maintenance that the user interface may prompt the user to perform on the dialysis system includes but is not limited to: sterilization of the system, changing water filters, changing water sterilization components (e.g. UV sources, heating components), pump replacement or maintenance, changing the dialyzer, exchanging fluid lines.

The user interface may provide information to the dialysis system controller that it may use to prevent dialysis treatment from starting or stop treatment safely if it is determined that conditions are not suitable for dialysis treatment. In the set-up procedures before dialysis treatment begins, unsafe conditions that may cause the controller to prevent dialysis treatment may include, but are not limited to: the need for maintenance on components of the dialysis system such as the dialyzer, pumps, water filtration and purification systems, bolus administering components, or sensors; lack of data from the patient monitoring system; sterilization service due; or any combination thereof.

During dialysis treatment, the status of the dialysis system may change such that continuing operation of the system would result in use of the system in an unsafe manner, potentially harming the patient. Use of the system in an unsafe manner may include use when any of the dialysis system, patient monitoring system, or control system is not performing suitably. A system or component is not performing suitably when it cannot achieve the flow rates or temperatures desired as set by a user using the user interface or when a system or component cannot send information regarding flow rates, temperatures, or patient status to the user interface. Use of the system in an unsafe manner may also include but is not limited to: use when the patient is not properly attached to the system, use when information regarding the patient's blood pressure and/or pulse are not available, use when the patient's blood pressure and/or pulse rate are outside of the ranges considered safe for dialysis, use when the water purity no longer meets required levels, use when the dialysate produced does not meet the required conductivity or ionic composition, use when the change in blood fluid volume set by the user can no longer be met, use with concentrate solution that is not suitable for use with a specific patient that is to be treated; use with concentrate solution that has not been prescribed for a patient by a medical practitioner; or any combination thereof.

When the user interface or dialysis system controller fails to receive status information from any part of the dialysis system of the patient monitoring system, the user interface may prompt the user to verify connection of the control system to the system and may also prompt the user to verify functioning of the particular system. If the user interface or any controller receives information that any part of the dialysis system or patient monitoring system is malfunctioning such that there is a sudden change in performance or the system is not reaching user input values for flow rates or temperature, the user interface may prompt the user to verify functioning of the particular system. It may be the case that the dialysis system controller or secondary controller detects continued malfunctioning in one or more parts of the dialysis system or patient monitoring system, such that even after prompting the user to verify functioning of the system repeatedly, the function is still unsuitable for dialysis treatment. In such a case, the dialysis system controller and/or secondary controller may cease the dialysis treatment and may indicate to the user via the user interface that treatment is ending at that time.

In the case when the patient is not properly attached to the system, the patient may have become detached from the system and thus may have triggered the detachment sensor. Upon receiving information that the patient has become detached from the system or attached in a manner that does not allow for perfect transfer of blood to and from the patient, the user interface may inform the user and the dialysis system controller may initiate proceedings within the dialysis system for cessation of treatment. In the case where the user interface or secondary controller ceases to receive information regarding the patient's blood pressure and/or pulse rate, the user interface may prompt the user to check that the patient monitoring device is functioning properly and may prompt the user to check the status or condition of the patient via the user interface. When the user interface or secondary controller receives information that the patient's blood pressure and/or pulse rate readings are no longer in the range where the dialysis treatment can safely be administered, the user interface may inform the user and may prompt the user to administer a saline solution bolus. If the user interface or secondary controller detects that the patient status is greatly outside of the acceptable ranges, the user interface may inform the user and prompt the user to obtain emergency medical help and additionally may cease the dialysis treatment.

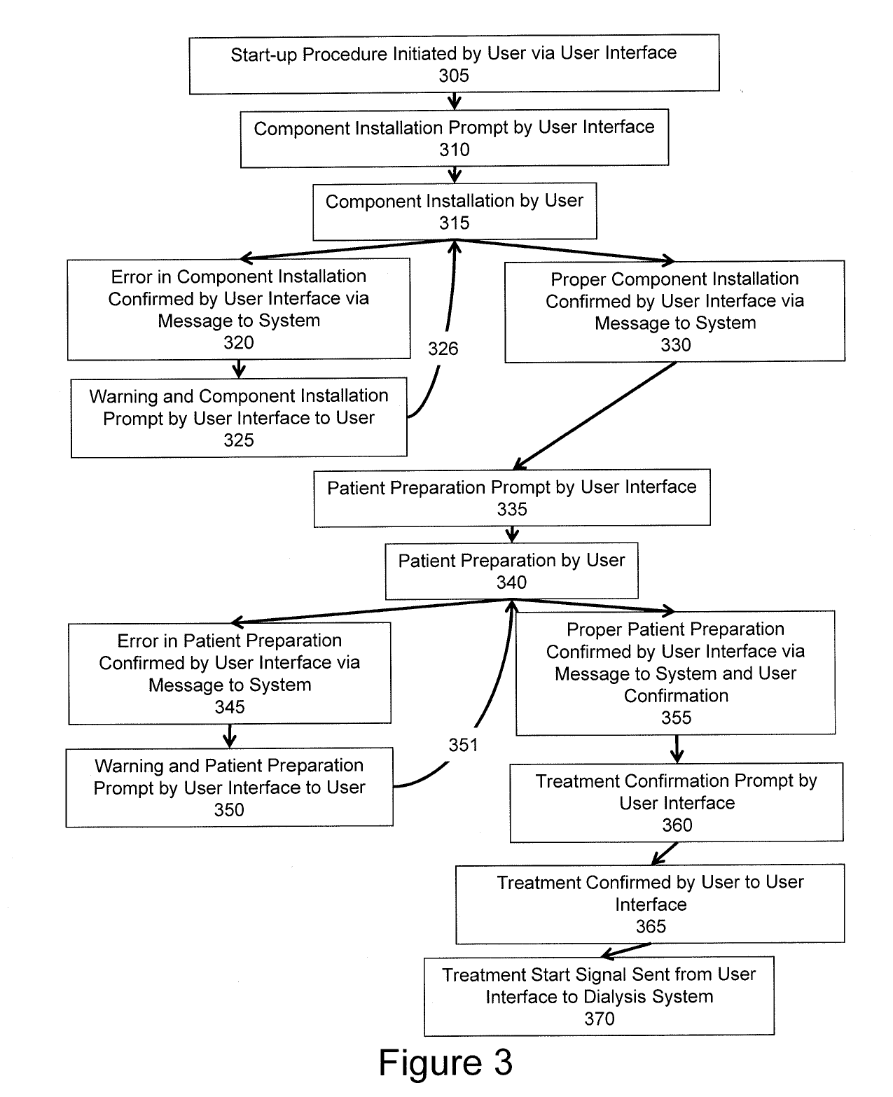

FIG. 3 illustrates an implementation of how the user interface guides a user through the start-up procedure to ensure safe operation of a dialysis treatment system when the system is being used by a patient, a caregiver, or other non-medical person. The start-up procedure can be initiated by the user via the user interface 305, the user interface prompts the user to install a component needed by the dialysis system 310. The component required by the system may be one required by routine maintenance, such as a water filter, or it may be a disposable component that is changed with each treatment, such as a saline solution source. The components can include, but are not limited to the blood set, the dialyzer, the heparin syringe, the saline solution source (saline bag), the acid concentrate container and bicarbonate concentrate container, patient monitoring items, and filters. The order of component placement may be: first the blood set, then the dialyzer, heparin syringe, saline bag, acid concentrate, bicarbonate concentrate, blood pressure cuff, and then finally the disconnection sensor. The component required by the dialysis system may be one that is removed after each treatment for cleaning and sterilization that must be replaced prior to each dialysis treatment.

After the component is installed by the user 315, the dialysis system may send information regarding the system status to the user interface via the dialysis system controller. The dialysis system may indicate on the user interface that there was an error in the installation of the component 320. If so, the user interface may indicate this to the user, and the user interface may issue an alert and prompt the user to install the component again 325. Between the issuance of the prompt to reinstall the component and the attempt by the user to correctly place the component, the dialysis system controller and/or the secondary controller may preclude the user from continuing with the start-up procedure 326. Once the dialysis system indicates to the user interface that the component was placed correctly 330, the user interface may prompt the user to install a subsequent component until all components are placed correctly or the user interface may prompt the user to prepare the patient for treatment 335.

The user (including the patient) can prepare the patient for dialysis treatment 340 in one or more steps. At each step, either the dialysis system or the patient monitoring system may provide information regarding the disposition of the patient to the dialysis system. The user interface may receive information that the patient is not correctly prepared for dialysis treatment 345. This may include the patient's blood pressure or pulse rate being outside of the range acceptable for safe dialysis treatment. A patient who is not properly attached to the dialysis system may also be considered not prepared for dialysis treatment. In such a case, the user interface may receive this information and may cause the user interface to indicate this information to the user and issue an alert and prompt to properly prepare the patient 350. Between the issuance of the prompt to prepare the patient for dialysis and the attempt by the user to bring the patient to a condition suitable for dialysis treatment, the secondary controller and/or dialysis system controller may preclude the user from continuing with the start-up procedure 351. Once the system indicates to the user that the patient is prepared for dialysis treatment 355, the user interface may present to the user the dialysis treatment conditions for confirmation 360. The user may then confirm the treatment conditions 365, and the user interface can send a signal to the dialysis system controller to begin the dialysis treatment 370. In some embodiments, treatment confirmation may not be the last action required of the user by the user interface prior to the start of dialysis treatment. In some embodiments, the user interface may prompt the user to open valves or clamps just prior to starting dialysis treatment.

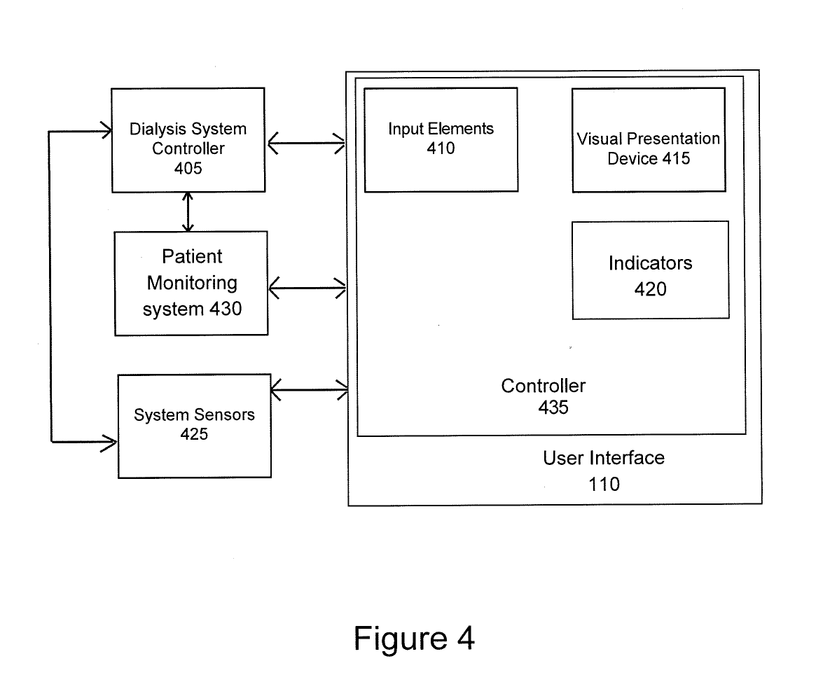

FIG. 4 shows a block diagram of the overall control of the dialysis system. The user interface 110 may be communicatively coupled to the dialysis system controller 405, system sensors 425, a patient monitoring system 430, and/or a user communication system controller 435 via a hardwired or wireless communication pathway. The user interface 110 communicates with a dialysis system controller 405 that is adapted to communicate with and control one or more of the subsystems (FIG. 2) of the dialysis system 105 including the filtration system, water purification system, dialysate preparation system and dialyzer system. The dialysis system controller 405 can be any type of computer controller or central processing unit (CPU) adapted to receive and process instructions and submit commands. The dialysis system controller 405 interfaces with computer-readable software code that resides in internal memory. The code can be loaded onto the computer and modified via an input-output interface of the system.

With respect to FIG. 4, the user interface 110 may include, but is not limited to, a visual presentation device 415, indicators 420, and input elements 410 and a controller 435. A visual presentation device 415 may be a computer screen, a television screen, an image projector, a touch screen, virtual reality glasses, or any device that allows a user to see images and read words generated by the user interface. Touch sensors may be used by the user interface to indicate to the user interface when interaction with a user has begun, to indicate if a user is manipulating a particular part of the dialysis system, or both.

The user interface 110 accepts data such as treatment parameters, patient data, and confirmation signals from the user through user input elements 410, as shown in FIG. 4. The user input elements 410 may include hard keys or buttons, such as an alphanumeric keypad or other buttons dedicated to specific tasks. The user interface 110 may accept input through various sensors as well as through a microphone, a key board, keys, buttons, joystick, data glove, or a touch screen with virtual, dynamic buttons (sometimes termed “soft buttons” or “soft keys”), or any combination thereof. The user interface may also accept input and may report data through telecommunications, such as through wireless communication or over a computer network via the user communications system controller 435. The user interface may accept input and may report data through direct contact with electronic media such as a solid state storage device (e.g. USB flash drive), a dongle, a computer disk or tape, or any combination thereof. The user interface may be made accessible to visually impaired users by the integration of a teletype device for input, by the ability of the user interface to accept voice commands, or both the integration of voice commands and a teletype interface.

The user interface may 110 generate any of visual, audio, tactile, vibratory, haptic prompts or alerts via indicators 420 and any combination thereof. As described, the user interface 110 may include a visual presentation device 415, a sound generating system, a vibration generating device, or any combination thereof. These devices and systems may be used to generate prompts and alerts to the user. The visual, haptic or audio signal may relate to any aspect of the dialysis system, such as the operational state of the dialysis system 105 or an alarm or error situation. The indicators 420 may include speakers and lights. The indicators 420 may also include haptic feedback that applies mechanical force, vibration and/or motion indicators to the user that provide tactile feedback to the user. Visual alerts or prompts may be issued by the user interface independent of other types of alerts or prompts. The user interface 110 may generate visual alerts and issue an alert sound simultaneously. A visual prompt and an audio prompt may be issued by the user interface simultaneously or may be issued separately, but in response to the same need for action by the user. A visual prompt may be an illustration, a video, a photograph, words, or a combination thereof. An audio prompt may be a tone, music, a spoken phrase, a spoken word, or a combination thereof. A vibration generating device may be used by the user interface to generate tactile or haptic feedback to the user or patient. The indicators 420 may also communicate with a user communication system controller 435 that includes a wireless transmitter that is configured to provide a wireless signal to a user or clinician, such as via a text message, telephone call, email, etc. or a combination thereof.

As shown in FIG. 4, the user interface 110 is in communication with one or more system sensors 425 that are communicatively connected to one or more of the subsystems of the dialysis system, such as through the dialysis system controller 405, for sensing one or more aspects of any of the subsystems. As mentioned, the sensors 425 may be incorporated into one or more of the subsystems shown in FIG. 2 and may include fluid flow sensors, pressure sensors, conductivity sensors, etc. for sensing and reporting one or more characteristics of fluid flowing through the system. The sensors 425 may also be communicatively connected to a patient monitoring system 430. The sensors 425 may be connected to a patient monitoring system 430 that includes a patient temperature sensor, a blood pressure sensor, a pulse rate sensor, or any combination thereof. The sensors may also be a component of the dialysis system controller 405.

The user interface 110 may include a controller 435 that is configured to enable interaction between the user interface 110 and the dialysis system controller 405, the patient monitoring system 430, as well as with the system sensors 425. The user communication system controller 435 may facilitate remote patient management by sending out information collected regarding patient status at scheduled intervals. Additionally, the user communication system controller 435 may allow for remote dialysis system management by regularly sending out system status information or sending information regarding alarm situations.

The user interface 110 is configured to facilitate interaction between the user and the dialysis system controller 405. In this regard, the user interface 110 can include one or more standardized walk-through procedures that guide the user through functional procedures of the dialysis system, including one or more start-up procedures, operational procedures, and shut-down procedures. During such procedures the user interface 110 causes one or more graphical user interfaces to be displayed on the visual presentation device 415 to provide instructions and/or feedback to the user in connection with the specific procedure being performed. Some implementations of user interface guidance procedures are now described.

Start-Up Procedure

In an implementation of a start-up procedure, the user interface system 110 is configured to guide the user through a start-up process wherein power is supplied to the dialysis system and the dialysis system is then configured for operation. Pursuant to such a start-up procedure, the user interface system 110 first detects a change in the power condition corresponding to power being supplied to the dialysis system 105. One or more of the sensors 425 can be configured to detect a change to the power condition, such as a voltage being applied to the controller 405 or the toggling of an on-off switch of the dialysis system 105. Upon power being supplied to the dialysis system 105, the user interface system 110 can initiate the display 415 and/or the indicators 420 to provide an indication to the user that the dialysis system 105 is in start-up mode. Such an indication may include the display of a page on the display 415 that includes an alphanumeric message or graphic indicative of the dialysis system 105 being in start-up mode. One or more audio or haptic feedback indications may also be initiated, such as a voice message that notifies the user that the dialysis system is going through start-up operations.

Next, the user interface 110 can query one or more of the sensors 425 to verify that the dialysis system 105 is in a proper state for running dialysis. The sensors 425 may sense any of a variety of conditions of the system. For example, the sensors 425 may sense chemical composition of fluid in the plumbing to verify that the dialysis system is in a sterilized state. The sensors 425 can also verify that the dialysis system 105 has been properly connected to any necessary hardware connections, such as to inlet plumbing for supply of water and outlet plumbing for drainage. In conjunction with the queries to the sensors 425, the user interface 110 provides one or more queries or prompts to the user should any user interaction be required. This may be in the form of the user interface 110 causing one or more pages to be displayed on the visual presentation device 415. The user interface 110 can cause the dialysis system 105 to halt any further action until proper user interaction has been achieved.

In an embodiment, the user interface 110 is configured to automatically initiate a process to ensure that the plumbing of the dialysis system is clean in order to avoid bacterial contamination of the plumbing. During the start-up procedure, the user interface 110 initiates a pre-cleaning process by causing sterilized liquid to flow from a source and through the plumbing while heaters of the dialysis system 105 are being powered up. In this regard, the user interface 110 can automatically actuate valves within the plumbing to ensure that the flow pathway is properly configured. For example, the valves may be set so that the plumbing temporarily receives fluid from a source of sterilizing liquid rather from the water supply upon commencement of a sanitation method for sanitizing components of the dialysis system.

An implementation of a sanitation method is described in the Application Publication No. US 2011-0189048, published Aug. 4, 2011 (U.S. patent application Ser. No. 12/960,373, filed Dec. 3, 2010), entitled “Modular Dialysis System;” which claims priority to U.S. Provisional Application Ser. No. 61/267,046, entitled “Dialysis System Sanitation,” filed Dec. 5, 2009. The aforementioned publication and patent applications are incorporated herein by reference in their entirety. During such a process, the user interface 110 can display one or more indications to the user that the pre-cleaning process is taking place and that dialysis cannot be performed until the pre-cleaning has been completed. The sterilizing liquid flows through all the components of the dialysis system until the water purification system 205 of the dialysis system 105 attains a desired operating temperature, such a pasteurization temperature. Upon the water purification system 205 reaching the desired operating temperature, the user interface 110 can automatically set the valves so that fluid flow to the dialysis system 105 switches from the supply of sterilizing liquid to water from the water supply. The water passes through the water purification system 205 (which has achieved the desired operating temperature) to flush the sterilizing liquid out of the plumbing. Various sterilizing solutions may be used. The solution, for example, can be a 1% chlorine in water mixture, or some other recognized water additive that can kill bacteria.

Upon completion of the pre-cleaning process and any other start-up processes, the user interface 110 can verify that the dialysis system 105 is in the proper status for performance of dialysis. When verification is complete, the user interface 110 can notify the user that the dialysis system 105 is ready for dialysis. For example, the user interface 110 may cause a page to be displayed on the visual presentation device 415 to notify the user such as by a graphic or illustration accompanied by text or by illuminating a light that corresponds to the dialysis system controller 405 being in a “ready” state. Prior to reaching the dialysis system's various preset or operator-set operating parameter(s), such as flow rates and operating temperatures, the dialysis system may be locked and prevented from being operated as a dialyzer, in order to maintain patient safety. Additionally, if the user interface 110 receives input or information that the patient is not ready for dialysis, such as having an initial blood pressure reading that is too high or too low to safely perform dialysis or not being connected properly to the dialysis system, the dialysis system 105 may be prevented from being able to be operate as a dialyzer, in order to maintain patient safety. The user interface 110 may receive initial patient status information from the patient monitoring system or user input.

Operational Procedure

With the start-up procedure complete, the dialysis system 105 can be prepared to perform dialysis on the patient. With reference to FIG. 4, the user interface 110 is configured to guide the user through the steps for performing dialysis, such as by displaying one or more pages on the visual presentation device 415 that walk the user through operation of a dialysis procedure.

The pages may include one or more questions or prompts that request information from the user, which information the user may provide via the input elements 410, such as via a touch screen or hard buttons. The user interface 110 may request any of a variety of information from the user, including for example, blood pressure, time elapsed since last dialysis procedure, user weight, height, nutritional and quality of life input, etc. The dialysis system controller 405 or user interface controller 435 is configured to use user-supplied information in combination with internally-stored data or externally-supplied data to perform calculations for the user and provide suggestions or estimates for consideration by the user in determining how to perform the dialysis. For example, the dialysis system controller 405 may be provided with the patient's estimated dry weight, and can then automatically calculate the amount of fluid that needs to be removed based on the patient's weight at the beginning of the treatment.

The user interface 110 may present data or inquiries to the user in a variety of manners. In an embodiment, the user interface 110 presents one or more pages to the user on the visual presentation device 415, wherein each page contains a fixed amount of information and none of the pages requires the user to scroll up or scroll down to access additional information. Rather than requiring scrolling to move between pages, the user interface 110 presents multiple pages in a tabbed format, wherein the user can move between pages by selecting a labeled tab on the visual presentation device 415.

Once the user interface 110 has obtained all necessary information from the user and performed any necessary calculations, the user interface 110 can prompt the user to commence dialysis, such as by presenting a page that directs the user to press a button, touch screen or otherwise interact with the user interface 110. In this regard, the user interface 110 can present the user with the option of performing different types of dialysis or can provide a recommendation on which type of dialysis would be proper based on the information provided by the user. The user can then commence dialysis by actuating the appropriate user input element 410, such as by actuating a “start” button. The dialysis system controller 405 then enables the dialysis system 105 to commence dialysis on the patient.

The user interface 110 provides periodic or continuous status updates to the patient throughout the pendency of the dialysis procedure. The status updates can relate to any of a variety of information related to the dialysis procedure, such as how much time is remaining, how much time has elapsed since commencement of dialysis, blood pressure, blood flow rate, how much fluid has been removed from the patient, etc. The status updates may be displayed on the visual presentation device 415 or can be in the form of audio updates via voice messages. In an embodiment, the status updates are purely informational and do not permit the user to make modifications to the dialysis procedure. In another embodiment, the user interface 110 permits the user to override or otherwise interact with the dialysis system controller 405 to modify the dialysis procedure. The user interface 110 may also provide recommendations for modification of the dialysis procedure based upon sensed conditions.

During the dialysis process, the user interface 110 interacts with the system sensors 425 in a feedback relationship to periodically or continuously monitor predetermined conditions of the dialysis system 105 and/or the patient 115. For example, the user interface 110 may query the system sensors 425 to verify that conditions such as blood flow rate, dialysate flow rate, blood content, etc. are within predetermined ranges. The user interface 110 is configured to initiate one or more alarm notifications to the user should conditions of the dialysis system 105 or the patient approach or fall within predetermined thresholds that represent a malfunction or a dangerous condition. The alarms may be in the form of haptic, visual and/or or audio signals to the patient. Desirably, the user interface 110 avoids the use of alarm or malfunction codes, such as numeric codes that would require the user to consult a manual to decipher the code. Rather, the user interface 110 uses graphical images and/or alphanumeric messages that can be easily understood by a user. In the event of an alarm or error notification to the user, the user interface 110 may automatically initiate step-by-step instructions to the user via the visual presentation device 415 that guide the user as to how to resolve the error or alarm condition. Or the user interface 110 may provide the user with the option of contacting the patient's clinician and/or service provider to provide assistance in resolving the error or alarm condition. The alarm condition can also prevent operation of the dialysis system and one or more of the subsystems of the dialysis system.

The type of condition that would trigger an alarm or error condition may vary. In an embodiment, the dialysis system is configured to sense when a needle or other type of blood vessel coupling device is inadvertently pulled out of the patient. In a dual needle system, this is called venous needle dislodgement. Potential complications associated with venous needle dislodgement range from minor blood loss to exsanguination (bleeding to death). This may occur when the needle delivering the filtered blood back into the patient is either partially or completely pulled out of the access site. Sensory data that could detect venous needle dislodgement may include related to blood loss (moisture sensor), blood flow rate, infrared data, or blood pressure.

The dialysis system may also be configured to sense error conditions that are more likely to occur as a result of the dialysis being performed at home rather than in a dialysis center where emergency assistance is more readily available. Such error conditions may vary and may include inadvertent disconnection of the dialysis system from a home water source, such as a home water tap, insufficient water pressure or cessation of water supply due to failure of a municipal water supply or running out of water where the home is on a fixed water supply. Such error conditions may be particularly exacerbated in home usage where home dialysis procedure can be performed nocturnally where a sleeping patient is not awake to notice that an error or alarm condition is occurring.

In an embodiment, a user can set the control system to a state such that the dialysis system controller 405 automatically initiates an automatic shut-down, without requiring user interaction, if a predetermined error condition takes place. The user interface 110 may also include an emergency override button that a user could select to signal the dialysis system controller 405 to override an operation of the dialysis system 105, or an emergency shut-down button that a user can select to immediately initiate a shut-down of the system.

As mentioned, the user interface 110 may include haptic feedback that interfaces with the user via a sense of touch. The user interface 110 may include one or more haptic devices (i.e. indicators 420) that provide tactile feedback to the user should an alarm condition arise. For example, the user interface 110 may monitor the patient's blood pressure, breathing rate, heart rate, alertness, etc. via sensors 425 and shake, vibrate or otherwise move the user should any patient condition fall outside of a safe range. The tactile feedback may also be configured to be enacted periodically such as to keep the patient alert or prevent the patient from falling asleep, if desired, and/or alert the patient to wake at a prescribed time determined by the patient.

The user interface 110 can be configured to notify the user upon completion or near-completion of the dialysis procedure. For example, if the dialysis procedure is performed at night while the patient is sleeping, the user interface 110 may be set to initiate an alarm that wakes the user prior to completion or at completion of the dialysis procedure or upon the occurrence of a condition requiring patient interaction or instruction or an operational event requiring interruption or shut-down of the system.

Shut Down Procedure

Upon completion of the dialysis procedure, the user interface 110 is configured to display one or more pages that guide the user through shut down of the dialysis system 105. In an embodiment, the user interface 110 is configured to automatically shut down the dialysis system 105 without requiring user interaction, such as upon completion of a dialysis procedure or upon passage of a predetermined time period after completion of the dialysis procedure. Such a configuration may be advantageous for nocturnal dialysis where the patient may be asleep when the dialysis procedure is completed. The user interface 110 is also configured to guide the user through a shut down procedure with interaction of the user. In this regard, the user interface 110 provides one more prompts to the user to guide the user through the necessary steps for shutting down the dialysis system 105. This may include requesting information from the user or prompting the user to perform certain tasks. Or the user interface 110 or dialysis system controller 405 may cause certain tasks to be automatically performed without requiring user interaction. In an embodiment, when the user commences shut down of the dialysis system, the user interface 110 automatically interacts with any of the dialysis subsystems to cause the dialysis subsystems to perform shut down steps. For example, the dialysis system controller 405 may issue commands to heaters in the dialysis system 105 to power down while maintaining fluid flow through the plumbing in order to flush the system of used or unclean fluid. Alternatively, the heaters may be powered down after running a sterilization cycle at elevated temperatures to flush the system before cooling. Alternatively, the user interface 110 may automatically cause a sterilizing liquid to flow through the plumbing until the water purification system attains near room temperature conditions. In this manner, the plumbing is maintained in a sterilized condition as the heaters shut down. The plumbing is then closed or “locked down” with sterilizing liquid present in the plumbing. The presence of the sterilizing liquid greatly reduces the likelihood of bacterial contamination during shutdown. Throughout the shut down procedure, the user interface 110 displays notifications to the user regarding the status of the shut down process, such as to notify the user of time remaining for shut down or to request user interaction that would facilitate shut down.

In an implementation, the system includes a user interface 110, a patient monitoring system 430, and a dialysis system 105 that is made up of a water filtration system, a water purification system, a dialyzer that includes pumps for circulating blood and dialysate, a dialysate preparation system for providing dialysate, and a dialysis system controller 405. The patient monitoring system 430 checks a patient's blood pressure and pulse rate before and during dialysis. The patient monitoring system 430 also verifies that the fluid lines attaching the dialysis system 105 to the patient's venous access point are indeed attached. Both the dialysis system 105 and the patient monitoring system 430 provide information to the user interface 110. The dialysis system controller 405 is capable of receiving operational instructions from the user interface 110 before and during dialysis treatment of a patient. In some embodiments, the dialysis system 105 is capable of receiving operational instructions from a user via the user interface 110.

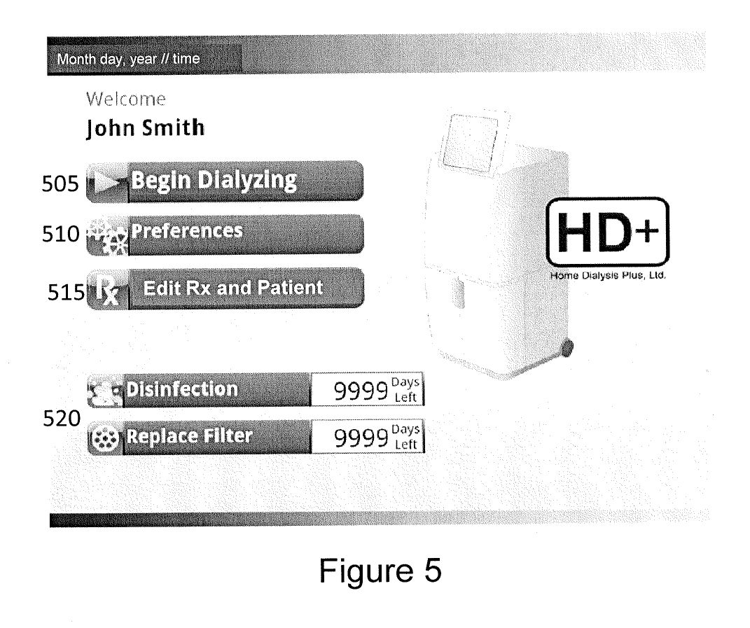

A variation of a start-up procedure is shown in FIG. 5. The user can be presented with a welcome screen by the user interface 110 on a visual presentation device 415. In some cases, the visual presentation device 415 is a touch screen. This welcome screen presents the user with information and options. The information on the welcome screen can include scheduled maintenance 520, such as disinfection due date and filter lifetime. Options the user has can include editing the prescribed hemodialysis treatment 515, editing the patient information 515, viewing and editing preferences 510, and beginning dialysis 505. If the user is a medical professional, such as a dialysis nurse, physician, nephrologist or other para-medical professional, the user may choose to edit the prescribed treatment 515. The user may be the patient or a caregiver to the patient, and on the welcome screen the user may choose to direct the system to begin dialysis 505 (begin dialyzing).

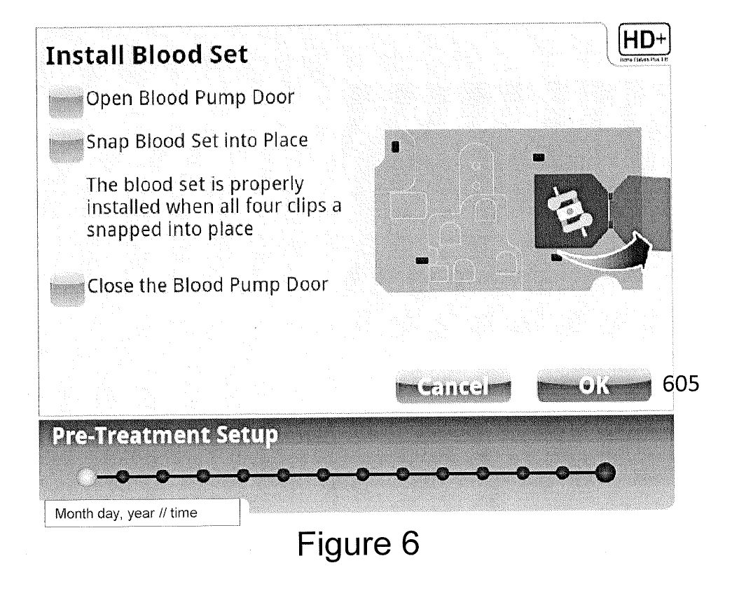

As shown in FIG. 6, when the user selects to begin dialysis, the user interface 110 can begin to visually present the steps of the start-up procedure (“Pre-Treatment Setup”) to the user. Audio presentation may accompany the visual display of information. The first step of the start-up procedure can be “Install Blood Set.” In this step a blood set is installed into the blood pump of the system. Once the user has followed the instructions on the screen of the user interface 110, the user can select “OK” 605. At this point the user interface 110 may request information from the dialysis system controller 405 to verify that the blood set has indeed been installed correctly. If the blood set has been installed incorrectly, the user interface 110 may prompt the user to try installation again visually or with a sound prompt. If the blood set has been installed incorrectly, the dialysis system controller 405 or user interface 110 may prevent the user from proceeding to the next step in the start-up procedure.

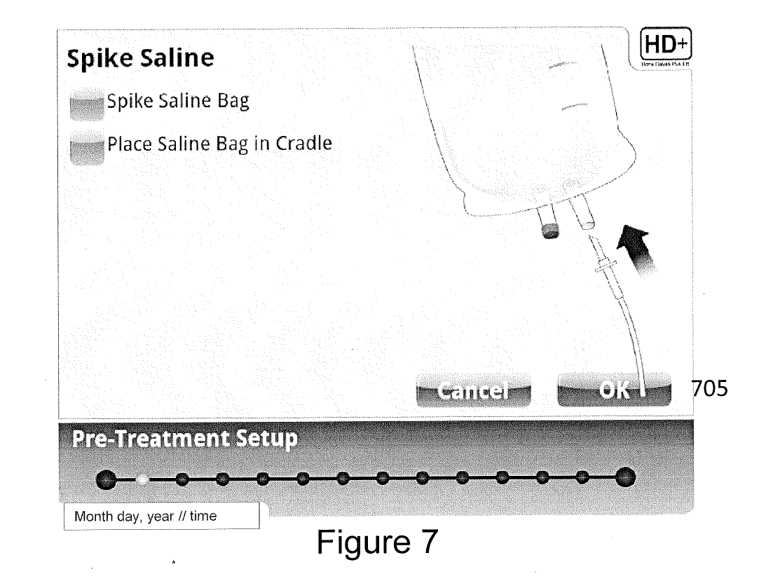

As shown in FIG. 7, following correct installation of the blood set into the blood pump, the user interface 110 can direct the user to “Spike Saline.” This step can include piercing a bag saline solution with a connection to the system. The user interface 110 can display visual prompts on the visual presentation device to help the user accomplish this step. Once the user has completed spiking and placement of the saline bag, the user can select “OK” 705. At this point the user interface 110 may request information from the dialysis system controller 405 to verify that the saline solution bag is properly in place. If the saline solution bag has been installed incorrectly, the user interface 110 may prompt the user to try installation again visually or with a sound prompt. If the saline solution bag has been installed incorrectly, the dialysis system controller 405 or user interface 110 may prevent the user from proceeding to the next step in the start-up procedure.

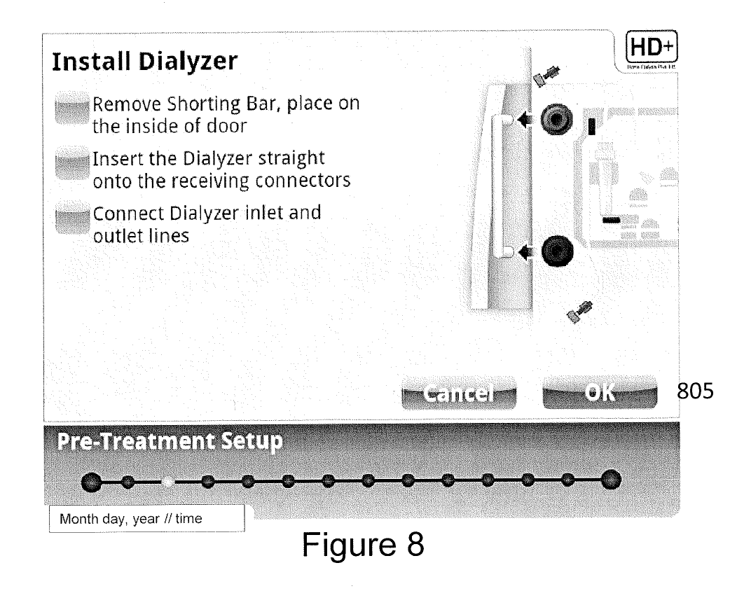

FIG. 8 shows the next step in the start-up procedure is “Install Dialyzer.” This step can include opening the system, inserting a dialyzer into the system, and connecting inlet and outlet fluid lines to the dialyzer from the rest of the system. The user interface 110 can display visual prompts on the visual presentation device to help the user accomplish this step. Once the user has completed insertion and connection of the dialyzer, the user can select “OK” 805. At this point the user interface 110 may request information from the dialysis system 105 to verify that the dialyzer is properly in place. If the dialyzer has been installed incorrectly, the user interface 110 may prompt the user to try installation again visually or with a sound prompt. If the dialyzer has been installed incorrectly, the dialysis system controller 405 or user interface 110 may prevent the user from proceeding to the next step in the start-up procedure.

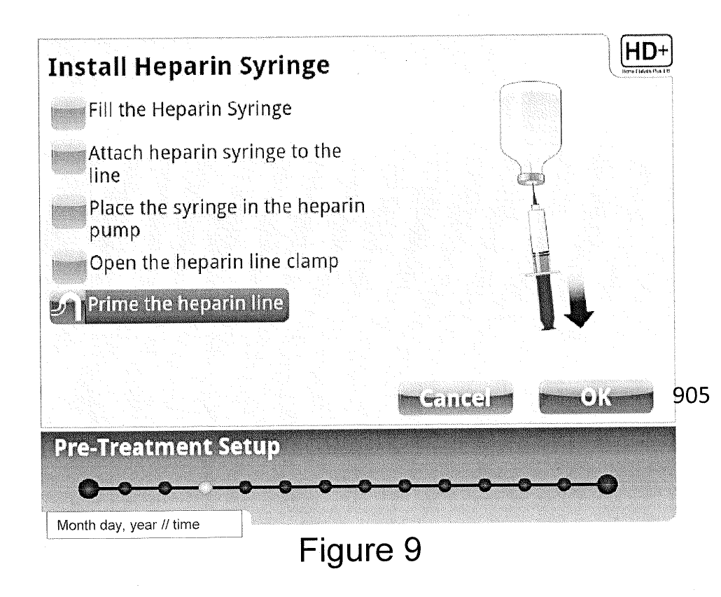

As shown in FIG. 9, following installation of the dialyzer, the start-up procedure can continue with “Install Heparin Syringe.” This step can include filling a syringe with heparin, attaching the heparin-filled syringe to a fluid line attached to the system, placing the heparin-filled syringe to a dosing pump, opening the heparin line clamp, and priming the fluid line that introduces heparin from the syringe into the system. The user interface 110 can present visual prompts to the user listing these tasks. Audio instructions may also be provided. Once the user has accomplished all of these tasks and prompted the system to prime the fluid line from the syringe to the system, the user can select “OK” 905. At this point the user interface 110 may request information from the dialysis system 105 to verify that the heparin syringe and heparin line are properly in place. If the heparin syringe has been installed incorrectly, the user interface 110 may prompt the user to try installation again visually or with a sound prompt. If the heparin syringe has been installed incorrectly, the dialysis system controller 405 or user interface 110 may prevent the user from proceeding to the next step in the start-up procedure.

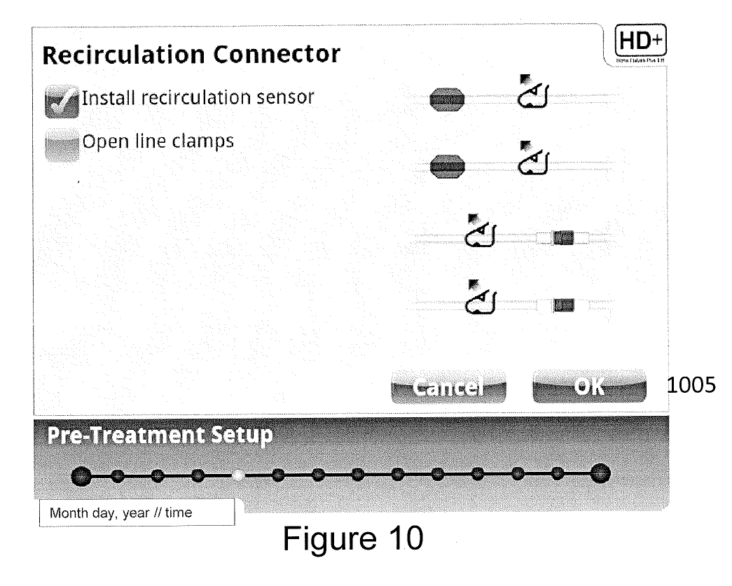

As shown in FIG. 10, after installing the heparin syringe the start-up procedure can proceed with setting up the “Recirculation Connector.” This step can involve installing a recirculation sensor and opening line clamps on the recirculation lines in the system. Visual, and optionally audio, prompts to accomplish these tasks can be provided by the user interface 110. The user scan can elect “OK” 1005 after accomplishing these tasks. The user interface 110 may then check with the recirculation sensor to verify that the recirculation connector is ready for operation. If the recirculation connector is not ready for operation, the user interface 110 may prompt the user to try sensor installation or clamp opening again visually or with a sound prompt. If the recirculation connector is not ready for operation, the dialysis system controller 405 or user interface 110 may prevent the user from proceeding to the next step in the start-up procedure.

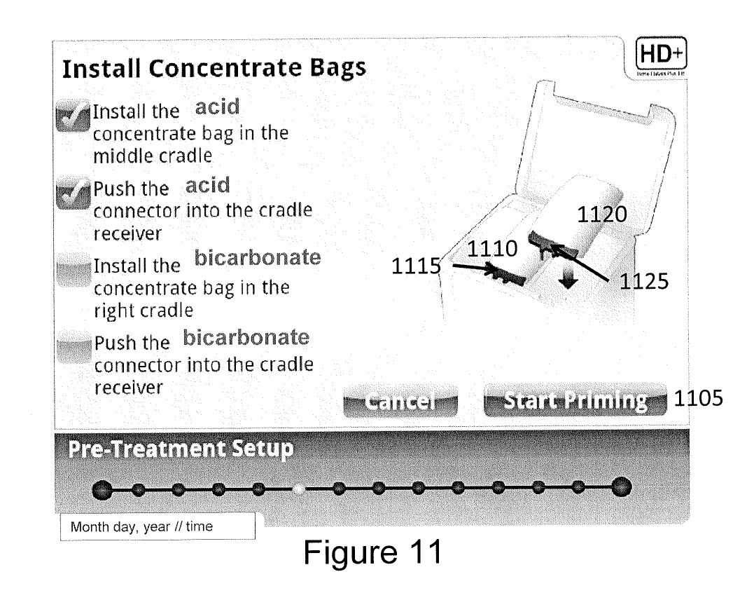

Once the recirculation connector has been attended to, the next step can be to “Install Concentrate Bags” (FIG. 11). The concentrate bags, or concentrate containers, hold solutions used to make dialysate. In this system, there can be at least two concentrate containers, one of acid solution 1110 and one of bicarbonate solution 1120. This step can involve placing each concentrate container in the appropriate cradle and pushing the connector on each concentrate container (1115, 1125) into the respective cradle receiver. Visual, and optionally audio, prompts to accomplish these tasks can be provided by the user interface 110. The visual prompts include a color-coded depiction of the placement of the concentrate containers that, in this example, corresponds to the coloring of the actual concentrate container (e.g. red for acid and blue for bicarbonate). The user can select “Start Priming” 1105 after accomplishing installing the concentrate containers. If the containers have been improperly installed, the system may not be able to successfully begin priming. In this case, the dialysis system controller 405 may send information to the user interface 110 indicating that priming cannot proceed. The user interface 110 may prompt the user visually or with a sound prompt to reinstall one or both of the concentrate containers. The dialysis system controller 405 or user interface 110 may preclude progress to the next step in the start-up procedure if the dialysis system is unable to prime after installation of the concentrate bags.

The concentrate containers may include a RFID (radio frequency identification) tag that may be read by corresponding sensors when the container is installed in the dialysis system. The RFID tag may be correlated to a certain mixture of dialysate concentrate that in turn corresponds to a treatment for a specific patient. The RFID tag information may be matched against the treatment parameters programmed into the user interface for the patient. If the RFID tag information does not indicate that the concentrate container is filled with solution appropriate to or prescribed for the patient the system is preparing to treat, the user interface may indicate this to the user and the dialysis system controller may not allow start-up to proceed. The concentrate containers may be filled with concentrate solutions having sodium, magnesium, calcium and potassium levels suitable for mixing dialysate prescribed by a medical treatment provider for the patient. A large variety of formulations such as low/high calcium and high/low potassium are considered herein to accommodate a variety of patient types. Concentrate formulations can be supplied, for example, by Diasol, Inc. (San Fernando, Calif.).

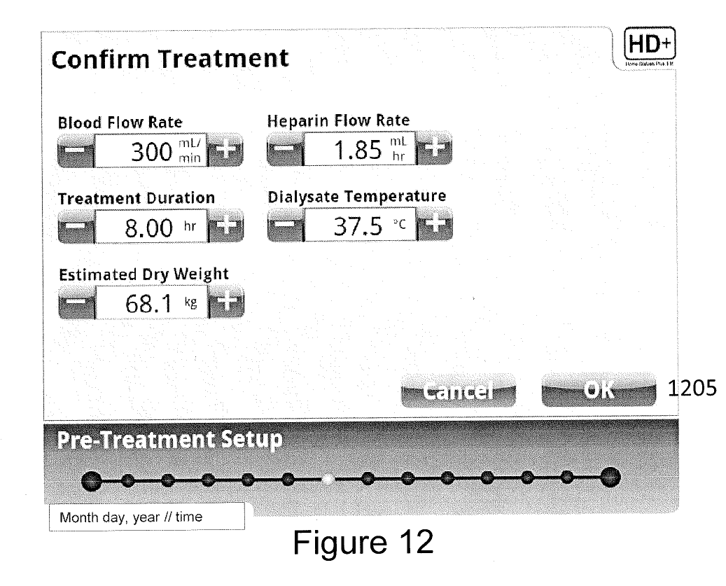

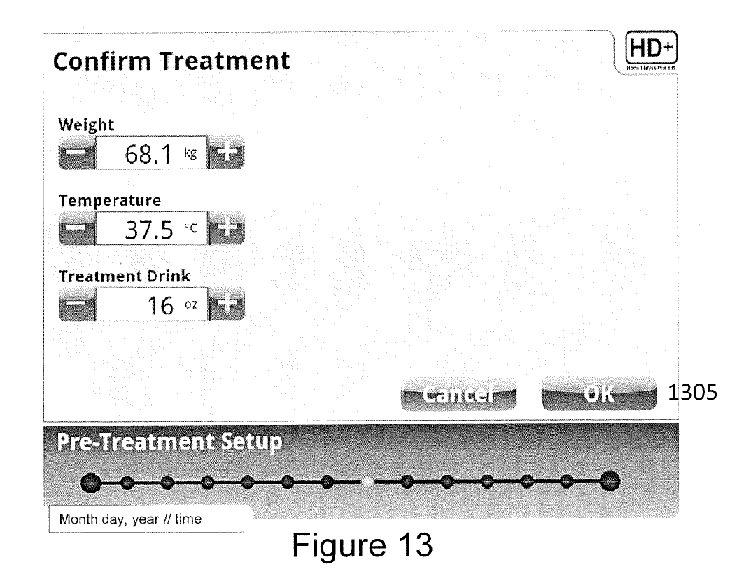

The next step in the start-up procedure can be “Confirm Treatment,” as shown in FIG. 12 and FIG. 13. In this step, the user interface 110 can provide a visual display of various performance or treatment parameters as well as patient parameters that cannot be detected using the patient monitoring system 430. The user interface 110 can allow the user to change the displayed values. The changes in values can be used by the dialysis system controller 405 to control the pumps and heaters of the system appropriately. The performance or treatment parameters can include, for example, blood flow rate, heparin flow rate, treatment duration, and dialysate temperature. The patient parameters, or pre-treatment information, can include, for example estimated dry weight, weight, temperature, and fluids orally consumed by the patient during treatment. The listing of parameters may be on multiple views of the visual presentation device 415 such as a touch screen. The user can confirm that the parameters are as desired by selecting “OK” 1205, 1305. Following this confirmation, the user interface 110 can provide instructions to the dialysis system 105 based upon these parameters. Then the user interface 110 can proceed to the next step in the start-up procedure.

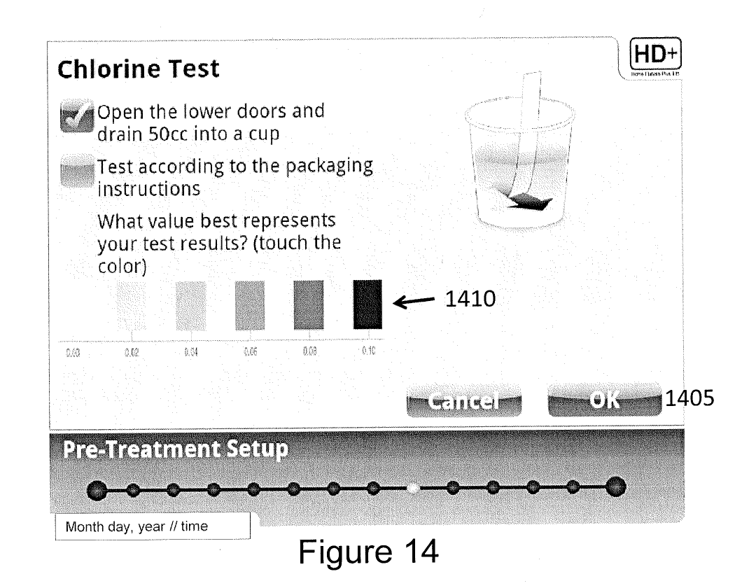

Following treatment confirmation, the user interface 110 can prompt the user to perform a “Chlorine Test” as shown in FIG. 14. The chlorine test can involve draining an appropriate amount of solution from the system into a cup and using a provided test strip detects the level of chlorine in the solution. The user can be prompted to perform this test and enter into the user interface 110 the chlorine level indicated by the test strip after insertion into the solution. The user can make this indication by touching a color or a value representative of the color on, for example a touch screen 1410. The prompts to perform the chlorine test and make an indication may be visual or visual and audio prompts. After performing the test and making the indication, the user can select “OK” 1405. The user interface 110 may relay the indication to the dialysis system controller 405 so that the dialysis system 105 may adjust parameters, such as water purification parameters, accordingly. The dialysis system controller 405 or user interface 110 can then allow the user to proceed to the next start-up step, or prevent the next start-up step if the chlorine level is too high.

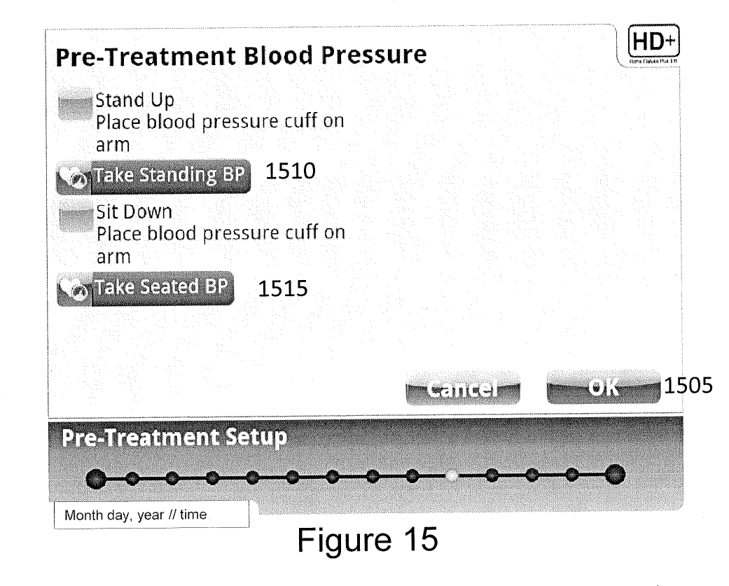

The next start-up step can involve making measurements using the patient monitoring system, specifically taking the patient's “Pre-Treatment Blood Pressure” as shown in FIG. 15. The user interface can present the user with the choice of performing the measurement while the patient stands or is seated. The user interface 110 can instruct the user to have the patient either sitting or standing and place the blood pressure cuff on the arm of the patient. The user can then select (such as on a touch screen) either “Take Standing BP” 1510 or “Take Seated BP” 1515. Once the measurement is made, the user can select “OK” 1505 on the touch screen. The patient monitoring system or the user interface 110 may record this reading for future reference. The patient monitoring system of the user interface 110 may also relay this information to the dialysis system controller so that treatment parameters may be adjusted accordingly. Additionally, if the patient's blood pressure is not at a safe level, the dialysis system controller 405 or user interface 110 may not allow the user to proceed with the start-up procedures.

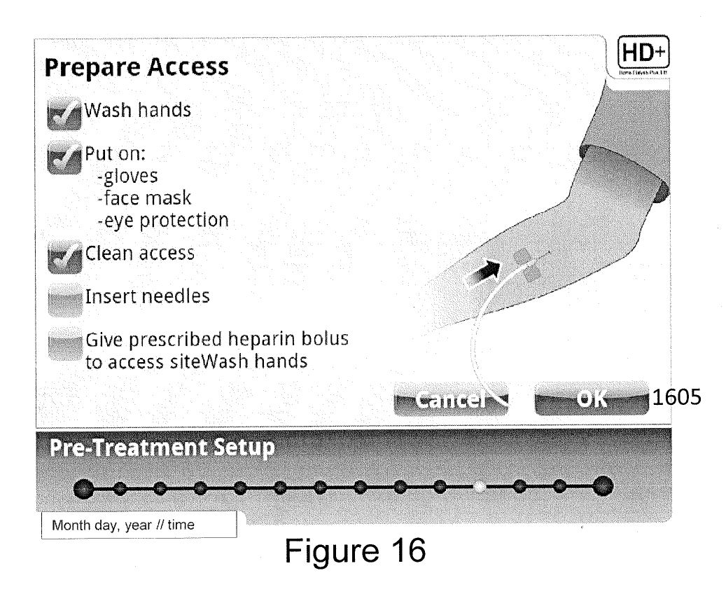

The patient's blood pressure has been taken and accepted by the control system. The next step can be “Prepare Access” as shown in FIG. 16. The access in this case can include the sites on an arm through which the patient's blood flows to and from the system as dialysis occurs. Access preparation can include: washing hands, putting on protective gear (e.g. gloves, face mask, eye protection), cleaning the access site, inserting needles, administering the prescribed heparin bolus to the access, washing hands again. The user interface 110 can prompt the user to do all of these tasks and illustrate what the prepared access should look like by presenting an image on the display. The user can then select “OK” 1605. The user interface 110 may then communicate to the dialysis system controller 405 that the access site has been prepared.

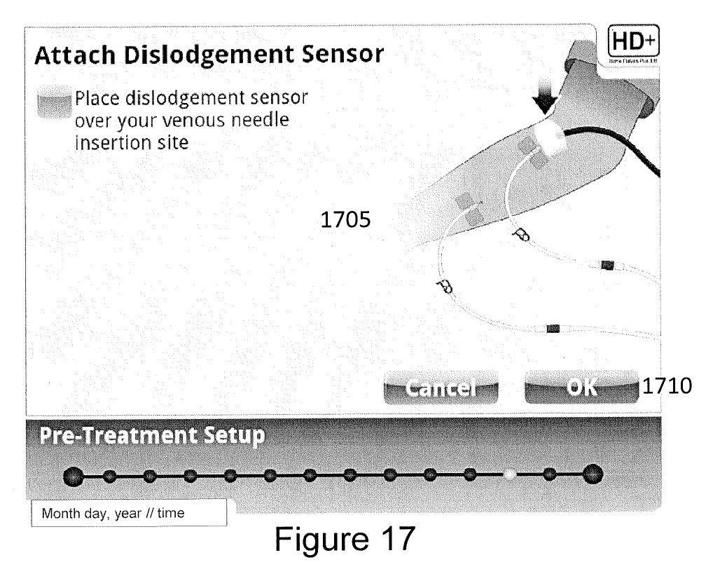

The next step in the start-up procedure can be to “Attach Dislodgement Sensor” as shown in FIG. 17. The sensor can communicate with the user interface 110, dialysis system controller 405, or patient monitoring system 430. The user interface 110 can prompt the user to attach the dislodgement sensor over the patient's venous needle insertion site. The prompt by the user interface 110 can include a diagram 1705 showing how the sensor should be placed. An audio prompt may accompany the diagram 1705. Once the user has successfully placed the sensor, the user can select “OK” 1710. The user interface 110 may confirm that a reading is received from the dislodgement sensor. If the dislodgement sensor is not sending a signal, the user interface 110 may prompt the user to reattach the dislodgement sensor. Additionally, if the dislodgement sensor is not sending a signal, the dialysis system controller 405 or user interface 110 may prevent the user from continuing with the start-up procedure.

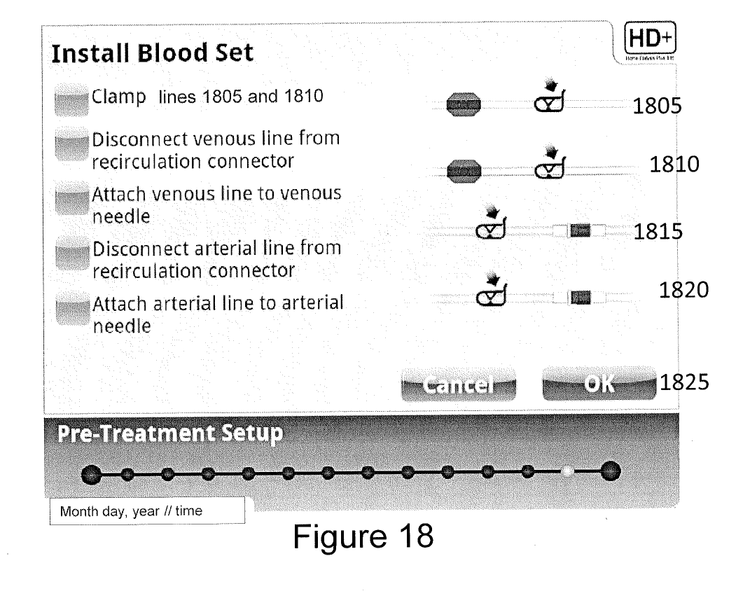

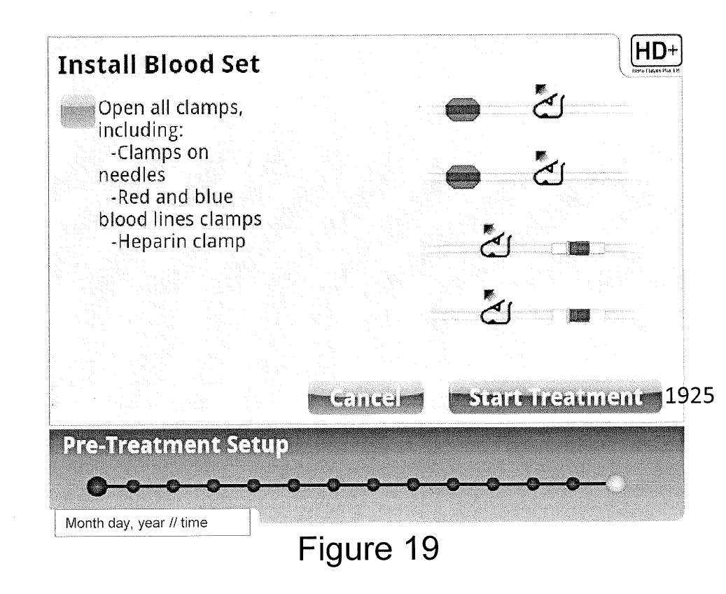

The final step of the start-up procedure can include a two-part step called “Attach Blood Lines,” shown in FIGS. 18 and 19 as “Install Blood Set.” As shown in FIG. 18, the user can be prompted to clamp fluid lines that provide blood to and take blood away from the patient 1805, 1810, disconnect the venous line from the recirculation connector and attach it to the venous needle 1815, and disconnect the arterial line from the recirculation connector and attach the arterial line to the arterial needle 1820. The user can then select “OK” 1825. The user interface 110 can then prompt the user to open all clamps as shown in FIG. 19. The prompt can specifically list clamps on needles, blood lines clamps, and the heparin line clamp. After the user has opened all of the clamps, the user can select “Start Treatment” 1925. At this point, the dialysis system controller 405 may send signals to the dialysis system 105 to begin providing treatment to the patient.

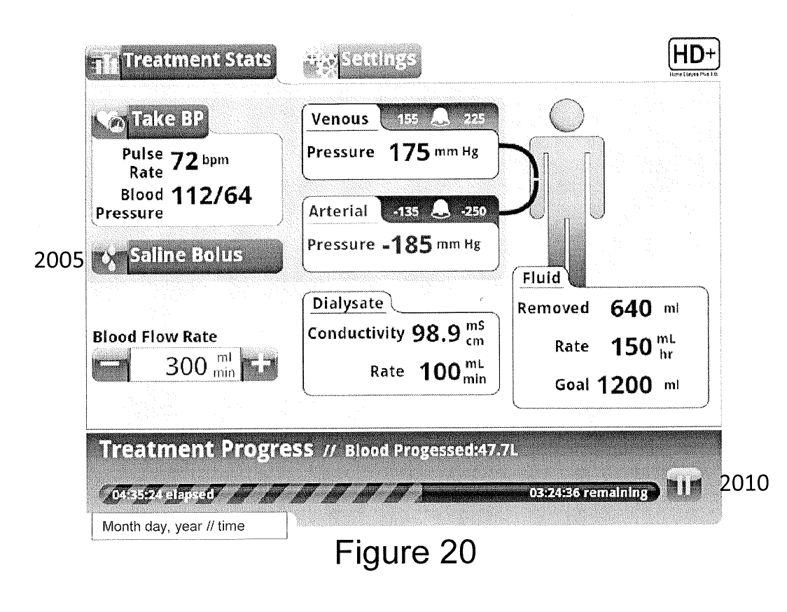

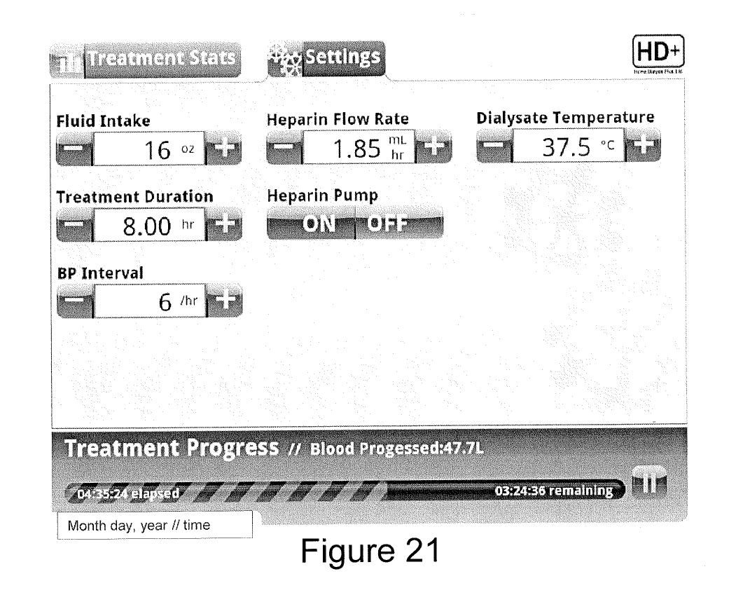

In an implementation of a system, after the start-up procedures have successfully been completed and while dialysis treatment is being administered, the user interface 110 may display status information and offer the user options to change treatment parameters on the visual presentation device 415 such as a touch screen (see FIG. 20). The user interface 110 may display, for example, the patient's blood pressure and pulse rate, the option to measure the instant blood pressure and pulse rate, the patient's venous blood pressure, the patient's arterial blood pressure, acceptable ranges for the venous and arterial pressures, an option to administer a saline bolus (saline solution) 2005 to the patient, the blood flow rate and the option to change that rate, dialysate conductivity, dialysate flow rate, how much fluid has been added or removed from the blood stream, the rate at which fluid is removed or added to the blood stream, the goal amount of fluid to be added or removed from the blood stream, the amount to blood processed at that instant, the treatment time elapsed, the treatment time remaining, and a virtual button (i.e. soft key) to pause the dialysis treatment 2010. During dialysis treatment, the user interface 110 may also offer the user the option to change settings using a touch screen as in FIG. 21. The settings may include, for example, fluid intake, heparin flow rate, dialysate temperature, treatment duration, use of the heparin pump (i.e. heparin pump on or off), the frequency of blood pressure measurements, and a virtual button (i.e. soft key) to pause the dialysis treatment. The user interface 110 may transmit changes made via the touch screen to the dialysis system 105 to alter the operating parameters as needed.

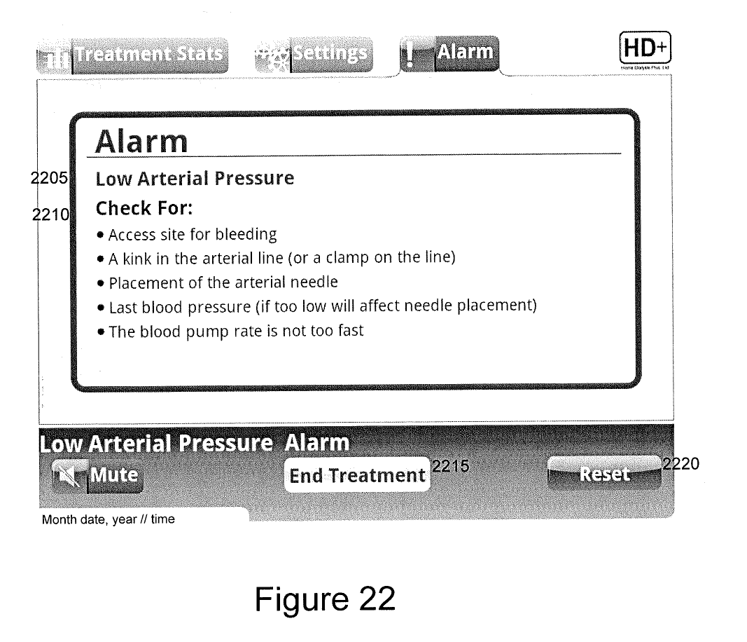

During treatment, the user interface 110 may also signal to the user when parameters are outside of acceptable conditions by visual alerts, sounds, or tactile alerts. Examples of conditions that could trigger alarms are dislodgement of the needle in the venous access site, blood pressure readings that are outside of the allowable ranges, and a dialysate conductivity reading that is abnormal. FIG. 22 shows an example of a visual alarm displayed by the user interface 110. The user interface 110 can indicate what the alarm 2205 is for, such as in FIG. 22 “Low Arterial Pressure.” The user interface 110 can also direct the user as to how to remedy the situation under “Check For” 2210. The user has the option to “End Treatment” 2215 or “Reset” 2220. The user may perform the checks indicated 2210, then press “Reset” 2220 to have the dialysis system restart treatment.

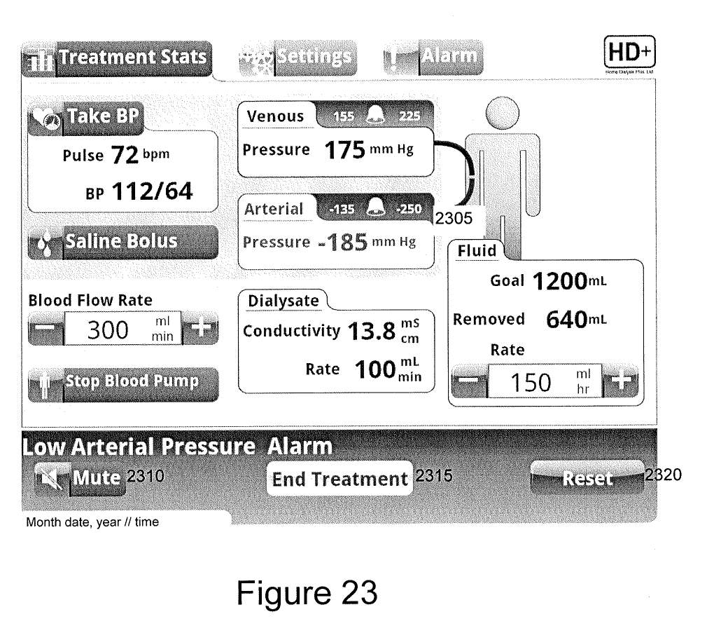

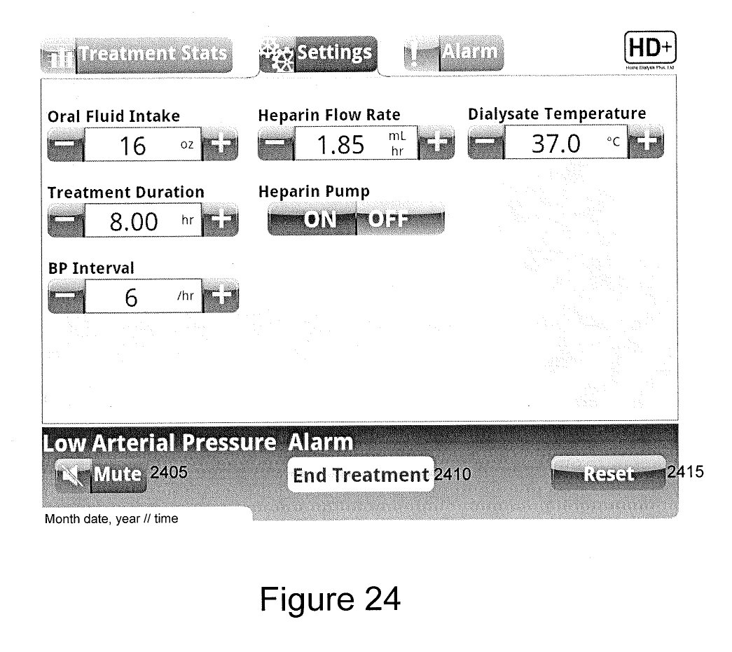

An alternate example of a view of the alarm is from the “Treatment Stats” tab view of the user interface, shown in FIG. 23. The arterial pressure readout may be highlighted 2305. The bottom treatment progress bar may indicate the alarm and offer the user the option to “Mute” the alarm 2310, “End Treatment”, 2315, or “Reset” 2320 after attempting to solve the problem. FIG. 24 similarly shows an example view of a visual alarm, but this time it is from the “Settings” tab. The bottom treatment progress bar may be replaced by an alarm indicator with the options to “Mute” the alarm 2405, “End Treatment”, 2410, or “Reset” 2415 and restart treatment.

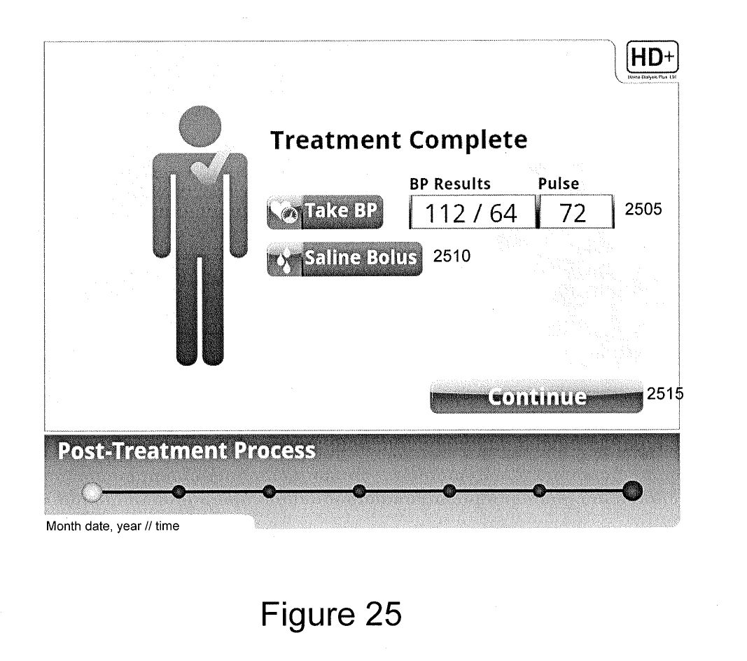

Once treatment has successfully completed, the user interface 110 may indicate that the treatment is complete visually, as shown in FIG. 25. The options to “Take BP” 2505 and administer a “Saline Bolus” 2510 can appear on the visual presentation device 415, or touch screen. If the results of a post-treatment blood pressure reading from the patient are low, then the user may administer a saline bolus. Once the user is satisfied with the information presented, he or she may select “Continue” 2515. This view is the beginning of the “Post-Treatment Process” as indicated on the treatment progress bar.

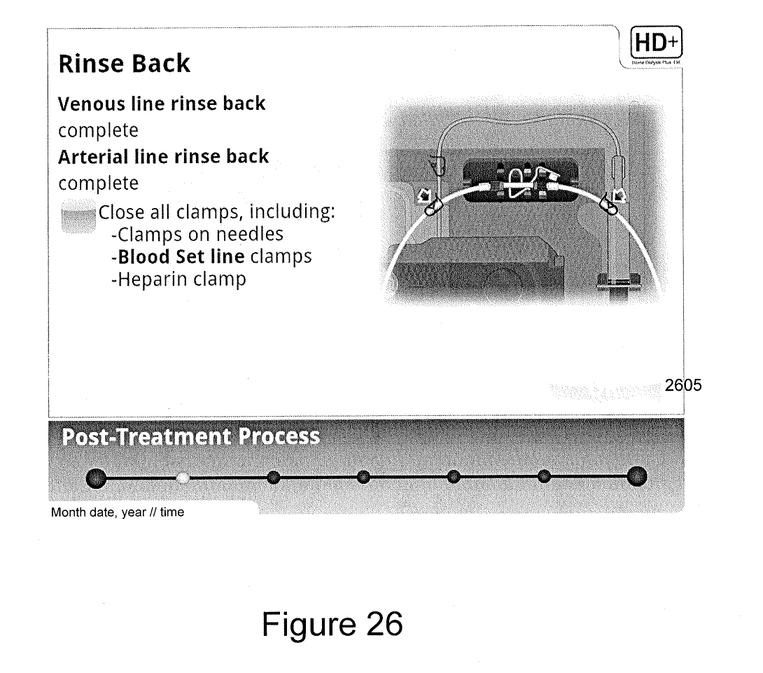

The next step in the “Post-Treatment Process” is the “Rinse Back,” as shown in FIG. 26. The view of the final visual prompt for this step is shown in FIG. 26. Once the user has completed all of the steps, he or she can select “OK” 2605. The user interface 110 may communicate with the dialysis system controller 405 to determine whether or not the rinse back has been performed correctly, and if needed, may preclude the user from proceeding to the next step. If the user interface 110 or dialysis system controller 405 does not allow the user to proceed, the user interface 110 may notify the user visually or with an audio prompt.

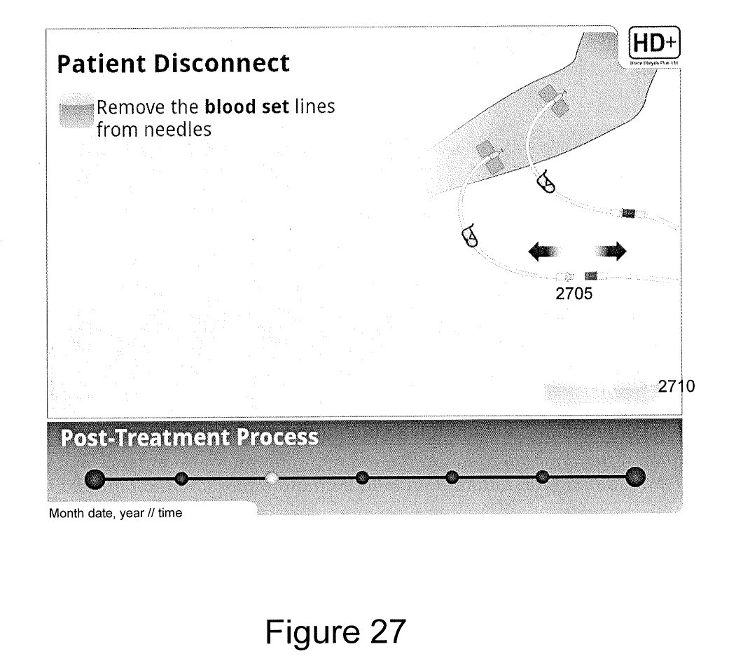

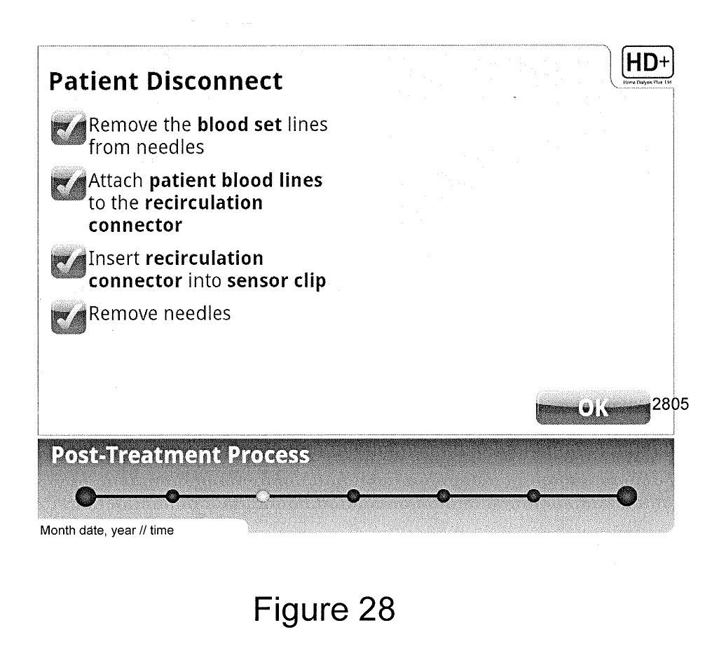

FIG. 27 and FIG. 28 show the “Patient Disconnect” step visual prompts. This step may follow the “Rinse Back” step. FIG. 27 shows an example of a prompt to remove the blood set lines and an illustration of that 2705. Once the user has accomplished this, he or she may select “OK” 2710 to proceed to the next part of the step. FIG. 28 shows an example of the visual prompt once a user has completed all of the parts of the “Patient Disconnect” step. Once the user believes he or she has completed everything satisfactorily, he or she may select “OK” 2805. This selection may prompt the user interface 110 and/or system sensors 425 to verify that all the parts of the Patient Disconnect step have been accomplished. If needed, the user interface 110 may prevent the user from proceeding in the Post-Treatment Process. If the user interface 110 does not allow the user to proceed, the user interface 110 may notify the user visually or with an audio prompt.

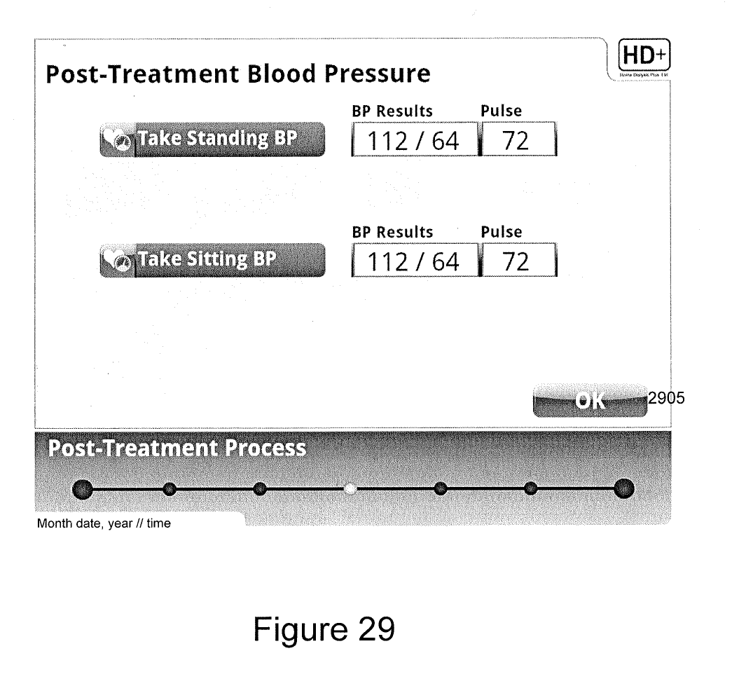

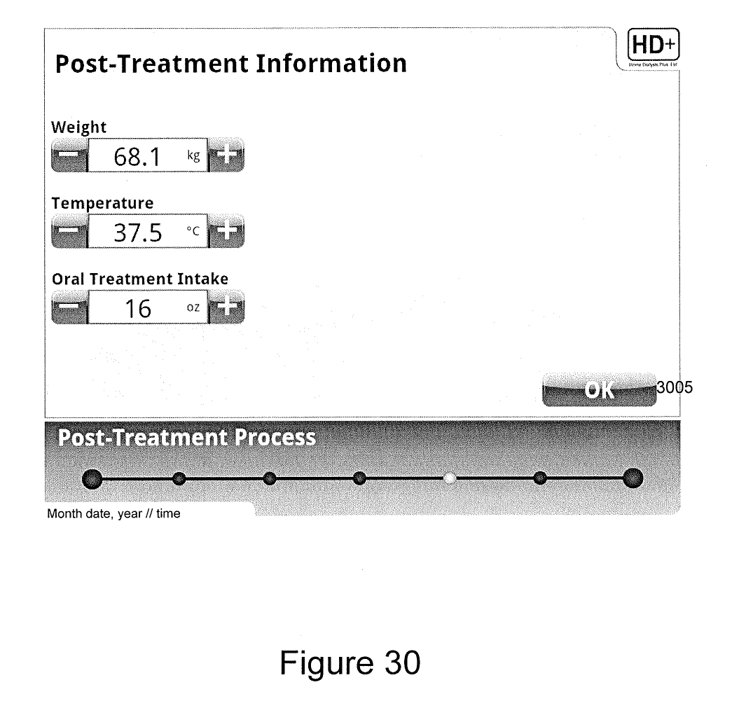

The next step in the Post-Treatment Process is the taking of the patient's “Post-Treatment Blood Pressure”. FIG. 29 shows an example of the visual prompt for this step. The options to take standing or sitting blood pressure can be presented. Once the user has obtained a blood pressure reading, he or she may select “OK” 2905 to continue. After accepting the patient's blood pressure, the user interface may display information to the user, “Post-Treatment Information”. An example of this information display is shown in FIG. 30. Once the user has verified the information, such as the weight of the patient, the temperature of the patient, and the amount of fluid the patient drank during treatment, the user may select “OK” 3005, to proceed.

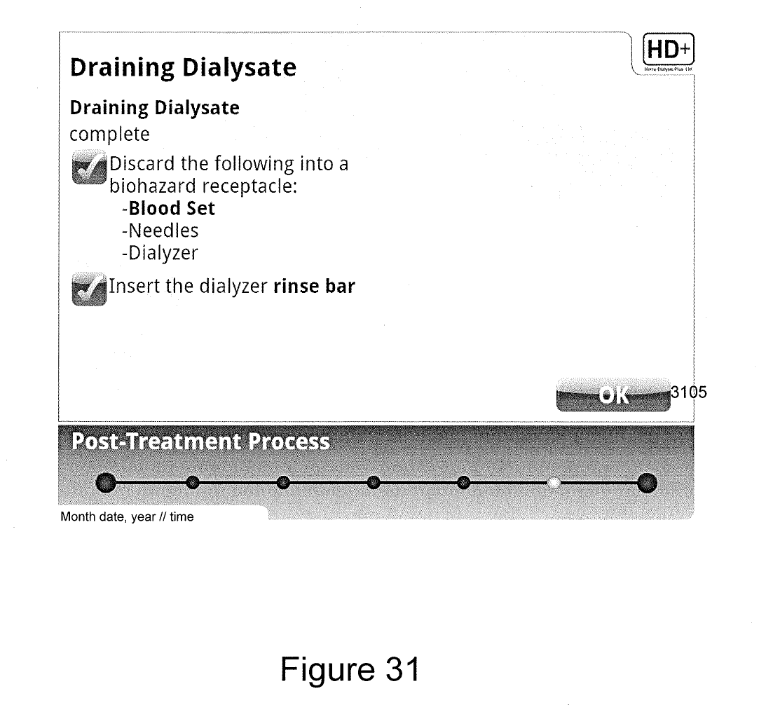

Following confirmation of the “Post-Treatment Information,” the user interface 110 may prompt the user to drain the dialysate, an example of which is shown in FIG. 31. The user can complete tasks which may include allowing the system to drain the excess dialysate, discarding the blood set, needles, and dialyzer into a biohazard receptacle, and inserting the dialyzer bar. When the user has completed the tasks, he or she may select “OK” 3105 to continue. The dialysis system controller 405 may confirm that the dialyzer rinse bar has been properly installed before allowing the user to proceed to the next step. If the dialysis system controller 405 detects that the dialyzer rinse bar has not been installed correctly, the dialysis system controller 405 may prevent the user form continuing and may prompt the user interface 110 to alert the user.

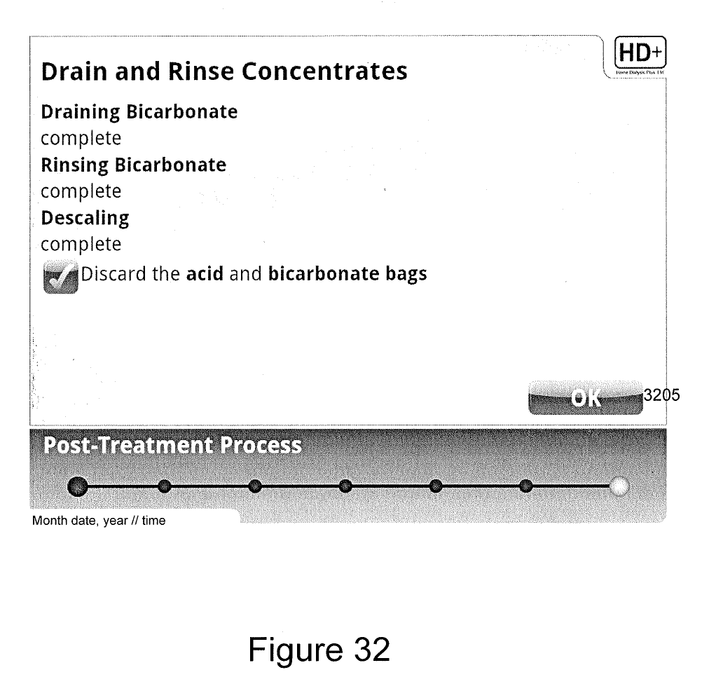

An example of the next visual prompt that the user interface 110 may present is shown in FIG. 32. This prompt is for the user to “Drain and Rinse Concentrates.” This visual prompt can lead the user to accomplish tasks including draining the bicarbonate, rinsing the bicarbonate and descaling followed by discarding the acid and bicarbonate containers. Once these tasks are completed, the user may select “OK” 3205 to proceed.

The final steps of the Post-Treatment Process can include disinfecting the fluid pathways and storing the unit. Disinfection of the fluid pathways may be done using hot water or chemicals. Chemical disinfection may include installing a chemical disinfectant container, installing conduits (e.g. concentrate rinse bar), and allowing the chemical disinfectant to permeate the system and soak. Chemical disinfection may take five hours or longer. Hot water disinfection may involve installing conduits as in chemical disinfection, but may not require the installation of any special fluid containers. The hot water disinfection may take an hour or longer.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Although embodiments of various methods and devices are described herein in detail with reference to certain versions, it should be appreciated that other versions, embodiments, methods of use, and combinations thereof are also possible. Therefore the spirit and scope of the appended claims should not be limited to the description of the embodiments contained herein.

What is claimed is:

1. A system, comprising:
a dialysis system, wherein the dialysis system comprises:
a filtration system configured to filter a water stream;
a water purification system configured to purify the water stream in a non-batch process;
a dialysate preparation system configured to produce a stream of dialysate from mixing one or more dialysate components with the water stream in a non-batch process;
a dialyzer system comprising:
a dialyzer configured to fluidly couple to the stream of dialysate and a blood stream, the dialyzer having a membrane separating the stream of dialysate from the blood stream, the membrane facilitating dialysis of the blood stream; and
a plurality of pumps configured to pump the stream of dialysate across the dialyzer; and
a dialysis system controller operatively coupled to the filtration system, water purification system, dialysate preparation system and dialyzer system; and
a user interface communicatively coupled to the dialysis system controller, the user interface configured to enable user interaction with the dialysis system and guide a user step-wise through set-up and shut-down of the dialysis system according to a pre-determined protocol, wherein the user interface communicates with the dialysis system controller to activate an alarm condition when a deviation from the pre-determined protocol is sensed.

2. The system of claim 1, wherein the alarm condition prevents operation of the dialysis system.

3. The system of claim 2, wherein the alarm condition prevents operation of at least one of the filtration system, the water purification system, the dialysate preparation system and the dialyzer system.

4. The system of claim 2, wherein the alarm condition alerts a medical practitioner via a text message, telephone call, email, or a combination thereof.

5. The system of claim 1, wherein the user is a dialysis patient on which the dialysis is performed.

6. The system of claim 5, wherein the dialysis patient is a home dialysis patient.

7. The system of claim 1, wherein the user is a caregiver to a dialysis patient.

8. The system of claim 1, wherein the dialyzer is selected from the group consisting of a microfluidic dialyzer, a hollow fiber dialyzer and a flow field dialyzer.

9. The system of claim 1, wherein the dialysis system controller is configured to control a flow rate of the dialysate stream through one or more of the plurality of pumps so as to perform one or both of the processes of ultrafiltration and hemodiafiltration on the blood stream while the blood stream is undergoing dialysis.

10. The system of claim 1, wherein the control system prevents unsafe operation of the dialysis system by the user.

11. The system of claim 10, wherein unsafe operation of the dialysis system comprises:
use with the filtration system not filtering the water stream suitably;
use with water purification system not purifying the water stream suitably;
use with the mixing system not producing dialysate suitably;
use with the dialyzer system not flowing the stream of dialysate suitably;
use with the dialyzer system not flowing the blood stream suitably;
use with the dialyzer system not performing ultrafiltration and/or hemodiafiltration suitably;
use with concentrate solution that is not suitable for use with a specific patient that is to be treated;
use with concentrate solution that has not been prescribed for a patient by a medical practitioner; and
any combination thereof.

12. The system of claim 1, further comprising a patient monitoring system comprising one or more sensors configured to detect information regarding a patient condition, wherein the patient monitoring system is in communication with the user interface.

13. The system of claim 12, wherein the patient monitoring system is configured to record the information regarding a patient condition and relay the information to the user interface.

14. The system of claim 12, wherein the one or more sensors comprises a detachment sensor that detects detachment of an access line from a patient venous needle insertion site to the dialysis system.

15. The system of claim 12, wherein the patient monitoring system further comprises a patient blood pressure monitor.

16. The system of claim 12, wherein the one or more sensors comprise a sensor to detect patient alertness.

17. The system of claim 12, wherein the user interface or dialysis system controller prevents use of the dialysis system by the user when the patient monitoring system detects that a patient condition falls outside of a range safe for dialysis to proceed.

18. The system of claim 1, wherein the system further comprises one or more sensors that detect information regarding a dialysis system condition.

19. The system of claim 18, wherein the dialysis system condition is selected from the group consisting of: maintenance required by the dialysis system, lack of information from the dialysis system, a change in flow rates within the dialysis system, inability of the dialysis system to achieve desired flow rates or temperatures, and detachment of the dialysis system from the patient.

20. The system of claim 1, wherein the pre-determined protocol comprises:
installation of components to the dialysis system, attachment of the patient to the dialysis system, attachment of a detachment sensor to the patient, testing of solutions generated by the dialysis system, confirmation of the treatment parameters, measurement of patient status, opening and closing clamps on fluid flow lines, performing maintenance on the dialysis system, and priming of fluid lines or pumps.

21. The system of claim 1, wherein the deviation from the pre-determined protocol is selected from the group consisting of: improper installation of one or more components to the dialysis system, improper attachment of the patient to the dialysis system, failure to obtain patient status measurements that indicate it is safe to proceed with dialysis treatment, failure to maintain the dialysis system, and failure to respond to alerts, alarms, or prompts from the user interface.

22. The system of claim 1, wherein the user interface is configured to interact with multiple users, wherein the users are selected from the group consisting of: a dialysis patient, a caregiver to a dialysis patient, a medical treatment provider, and a medical service provider.

23. A method of performing dialysis with a dialysis system, the method comprising:
prompting a user for input using a user interface, wherein the user interface is in communication with a dialysis system and configured to enable user interaction with the dialysis system and guide the user step-wise through set-up and shut-down of the dialysis system according to a pre-determined protocol, wherein the dialysis system comprises:
a filtration system configured to filter a water stream;
a water purification system configured to purify said water stream in a non-batch process;
a dialysate preparation system configured to produce a stream of dialysate from mixing one or more dialysate components with the water stream in a non-batch process;
a dialyzer system, comprising
a dialyzer configured to fluidly couple to the stream of dialysate and a blood stream, the dialyzer having a membrane separating the stream of dialysate from the blood stream, the membrane facilitating dialysis of the blood stream; and
a plurality of pumps configured to pump the stream of dialysate across the dialyzer; and
a dialysis system controller operatively coupled to the dialyzer system, the filtration system, the water purification system, the dialysate preparation system, and the user interface;
communicating the user input to the dialysis system controller;
obtaining status information from the dialysis system via one or more system sensors;
communicating the dialysis system status information to the dialysis system controller;
receiving information of one or more patient conditions of a patient attached to the dialysis system;
determining that the one or more patient conditions are suitable for dialysis treatment;
determining that the dialysis system status is suitable for dialysis treatment; and
using the user interface to operate the dialysis system.

24. The method of claim 23, wherein the user input comprises: direction to begin dialysis treatment start-up, changes to dialysis treatment parameters, confirmation of dialysis treatment parameters, patient status or condition information, confirmation of the performance of tasks during treatment start-up or shut-down, direction to start dialysis treatment, direction to stop dialysis treatment, acknowledgement of an alert or alarm, or any combination thereof.

25. The method of claim 23, further comprising alerting or alarming the user when a deviation from the pre-determined protocol is detected.

26. The method of claim 25, wherein deviation from the pre-determined protocol is selected from the group consisting of: improper installation of one or more components to the dialysis system, improper attachment of the patient to the dialysis system, failure to obtain patient condition measurements that indicate it is safe to proceed with dialysis treatment, failure to maintain the dialysis system, and failure to respond to alerts, alarms, or prompts from the user interface.
